(19) United States
(12) Patent Application Publication
(10) Pub. No.: US 2026/0057449 A1
(43) Pub. Date: Feb. 26, 2026

(54) SYSTEM, METHOD, AND APPARATUS FOR INVESTMENT COMPANIES WITH COMPLEMENTARY OBJECTIVES TO INVEST IN A SINGLE PORTFOLIO TO OBTAIN GREATER RETURNS WITH LESS RISK

(71) Applicant: Thomas David Forma, Southport, CT (US)

(72) Inventor: Thomas David Forma, Southport, CT (US)

(21) Appl. No.: 19/221,530

(22) Filed: May 29, 2025

Related U.S. Application Data
(60) Provisional application No. 63/673,691, filed on Jul. 20, 2024.

(51) Int. Cl. G06Q 40/06

(52) U.S. Cl. CPC G06Q 40/064; G06Q 40/062

(57) ABSTRACT

Computer-based system, method and apparatus aggregating data of equity and debt securities, and investment portfolios, to benefit multiple investment companies (ICs) with complementary objectives by transforming an investment portfolio into a source of significantly more returns for each investor IC's objectives by apportioning unequally the portfolio's benefits, risks and obligations to each IC invested in the portfolio. Components include a securities data aggregation computer (SDAC), a portfolio data aggregation computer (PDAC), a portfolio comparison computer (PCC), a Portfolio Modeling Computer (PMC), a computer modeling and displaying ways to optimize the benefits and obligations of the portfolio (CDBO). Computers use investment characteristics to dynamically display the portfolios and combinations of portfolios, to model alternative portfolios to serve the complementary objectives of each IC. An embodiment of the invention unites, in the creation and management of a single portfolio, two or more ICs with complementary objectives.

### CROSS-REFERENCE TO RELATED APPLICATIONS

This application is a U.S. Non-Provisional Utility patent application entitled, “SYSTEM, METHOD, AND APPARATUS FOR INVESTMENT COMPANIES WITH COMPLEMENTARY OBJECTIVES TO INVEST IN A SINGLE PORTFOLIO TO OBTAIN GREATER RETURNS WITH LESS RISK” which claims priority to co-pending U.S. Provisional Patent Application No. 63/673,691, filed on Jul. 20, 2024 entitled, “SYSTEM, METHOD, AND APPARATUS FOR INVESTMENT COMPANIES WITH COMPLEMENTARY OBJECTIVES TO INVEST IN A SINGLE PORTFOLIO TO OBTAIN GREATER RETURNS WITH LESS RISK” the contents of which are hereby fully incorporated by reference.

### FIELD OF THE EMBODIMENTS

The present invention relates to data management systems and more particularly to an automated system of aggregating and transforming data from disparate sources of securities' market behavior and resultant portfolios' market behavior for use in portfolio manager selection, as well as portfolio management and monitoring. In particular, the present invention relates to a system, method, and apparatus for manual and automated data input and management for use by multiple separate investment companies that invest in a single portfolio managed by one or more portfolio managers, so that by combining the investment companies' assets into a single portfolio they can allocate unequally to each investment company their single portfolio's features and risks, thereby significantly increasing the investment outcomes for each of their complementary objectives.

### BACKGROUND

Investors have been subjected to many problems that need to be solved: The “Fixed Income Problem”, the need for immediate access to portfolio management that already has been through a thorough fiduciary screening, and the need to sell capital gains on income-oriented investments without losing the income stream they own are three prominent problems. Six more problems also are listed below, totaling nine that need to be solved, or at least greatly mitigated.

THE FIXED INCOME PROBLEM: Investors have a long history of succumbing to “the fixed income problem” due to their efforts to increase investment performance. The investor search for increased returns has often brought them to invest in risky securities, including stocks and low credit-quality bonds. Over the past quarter century, the search for higher returns has expanded the range of risks for these investors to even riskier investments, including hedge funds, venture capital, private equity, private credit, options, futures, other derivatives, and junk bonds.

The Fixed Income Problem is a built-in characteristic of investments that provide periodic payments of the same amount over time. The problem is that fixed payments do not provide an increase in cash flow to keep up with inflation. As time passes, inflation causes the fixed level of payments to lose buying power. Additionally, any long-term source of fixed payments that has a maturity date (i.e., for return of the nominal initial principal amount) will provide the nominal amount that has lost buying power at the compounding rate of annual inflation. A corollary to low levels of fixed periodic payments is the search for higher returns elsewhere, resulting in higher risks being taken. The Fixed Income Problem is especially harsh for fiduciaries whose duties continue for many future decades, including but not limited to institutional investors who are required by law, contract, or moral obligation, to make many years' of payments, such as those to pensioners, universities, hospitals, and insurance policy beneficiaries.

The Fixed Income Problem has grown over the last 25 years, partially due to historically low interest rates, leading many fiduciary investors to assume greater and greater risks, some of which are described immediately below.

LEVERAGE RISK: Many such risks include leveraging investments by borrowing money that is added to their investment principal. Borrowing creates risk if the loan must be paid back before the investor can retrieve their original investment and any gain. Other leveraging efforts include the purchase of options and futures on investments. Because loans, options and futures have time limits, the end of their terms may happen at a moment when the investment has lost market value, which can force the investor to realize a loss. Margin loans also have exaggerated this risk by requiring the minimum margin to be met daily, which is quite risky in periods of volatile markets.

SPENDING RISK: Investors, especially fiduciary investors, also may have a responsibility to spend money from their portfolio. A portfolio is put at risk when assets are sold to make payments to beneficiaries. An example of such a situation: spending is needed at a time when markets are in a severe downturn, causing assets to be sold and money withdrawn, realizing losses. In the U.S. stock market, there have been ten downturns of 30% or more over the past century.

EXTRA MARKET RISKS: Investors often assume they need to take above average risks to obtain above average returns. Investors may find themselves with serious losses caused by their desire for above average returns. The current plethora of above average risk investments that seek above average returns provides no opportunity for investors to seek above average returns without the commonly associated levels of risk.

For example, investors seeking above average income often find that they must take higher risks to achieve such income. Investors seeking above average income often find their equity and debt investments take higher risks that include risks such as financial weaknesses, industry/sector risks, political risk, currency risks, and derivatives risks. Investors seeking above average capital gains also often find their equity and debt investments entail higher risks in pursuing above average capital gains, including financial weaknesses, industry/sector risks, political risks, currency risks, derivative risks, leverage risk, and inflation risk.

REDUCED TOTAL RETURN: The “tradeoff” is another concern with current investment opportunities: the necessity to reduce total return when seeking to increase one of the forms of investment gains. Investment choices generally involve finding a balance between the opposing characteristics of a single investment, leading investors to reduce exposure to one aspect of the investment to increase exposure to another aspect of the investment. For example, in equity and debt investments, one may invest for income and accept the likelihood of reducing the potential capital appreciation. Or one may invest to achieve greater capital appreciation and reduce the expected income.

SUSTAINABLE SPENDING: Wealth is commonly measured as the dollar value of an investment portfolio, which is sensible if the objective is long term accumulation. However, many of the world's largest portfolios are decumulating, and have a perpetual responsibility to spend. For portfolios with spending purposes, it is better to measure success as the portfolios' ability to sustain spending for the full span of the portfolios' responsibilities. Examples of decumulation portfolios include funds for pensions, insurance companies, trusts, endowments, and foundations. Spending from a portfolio's market value by periodic selling is risky, as markets can be volatile, and selling securities in a depressed market may make it impossible to recover asset values obtained before the markets fell precipitously. Alternatively, in market downturns fiduciaries may choose to limit security sales to meet their operational expenses, which often results in personnel layoffs, deferred maintenance, and cancellation of much-needed services and projects.

Over a century of U.S. stock market history, there have been 10 market declines of 30% or more. Selling at a market trough to meet spending responsibilities can permanently harm the long-term performance of a portfolio's market value and income stream. Many studies have documented the long-term negative effects of spending 5% or more of an investment portfolio or security by selling part of the investment. The responsibility to spend commonly entails providing money regularly, with increases that exceed the inflation rate. Funds with spending responsibilities include, but are not limited to, retirement plans (e.g. pensions, profit-sharing, IRA), endowments, foundations, Other Post-Retirement Benefit Plans (OPEB), and insurance companies.

BOND REINVESTMENT RISK: Fiduciary investors invest in bonds so that they may have a reliable stream of income. A serious risk of bonds arrives at maturity, when the principal is reinvested in new bonds. If rates are low, then the investor is locking in a low income stream for a chosen number or years. From 1981 to 2024 this was the risk that kept reappearing, leading may investors to seek growth in higher risk alternative investments such as bonds with low credit quality (‘junk bonds’), private equity, venture capital, foreign bonds, and derivatives.

Accordingly, there exists a long-felt but unresolved need for improved systems and methods that address the limitations of fixed income investments by enabling enhanced returns with reduced risk, particularly for fiduciary investors with long-term spending obligations.

BOND INVESTORS CAPITAL GAINS CONUNDRUM: Income-oriented investors periodically find they have capital gains they wish to realize but cannot sell without giving up their needed income stream. The unfulfilled desire to realize such capital gains is an age-old issue that begs for a solution.

PORTFOLIO MANAGER TRANSITIONS: Fiduciary investors periodically must replace underperforming portfolio managers, and that process may take several months to more than a year to complete due to requirements of the due diligence process, including but not limited to, committee meetings, an up-to-date manager search, interviews with portfolio manager candidates, and contract negotiations. If fiduciaries terminate the use of a portfolio manager, how do they invest those funds until a new portfolio manager is hired? Frequently an index fund is used temporarily despite the fact that the index fund has never been the subject of a fiduciary due diligence process.

### SUMMARY OF THE EMBODIMENTS

In accordance with the principals of the present invention, The Fixed Income Problem, the immediate access to securities that have undergone fiduciary due diligence, and the ability for income investors to realize capital gains without losing their income stream are all presented simultaneously with a solution by the present invention. Along with these three problems, several more problems are addressed by the invention, including leverage risk, spending risk, extra market risk, reduced total return, sustainable spending, and bond reinvestment risk.

The solution provided by the invention is counterintuitive and contrary to conventional wisdom. The automated computer-driven steps of the invention are not conventional. The invention is unique, non-obvious, useful, and transformative in providing substantially more returns for investors. The invention's mechanism and use of computers solves the problems listed in the Background, above. The invention's system, methods, and apparatus work in a manner opposite to all prior multi-purpose funds that were invested in a single portfolio. From the mid-1960's, and grandfathered into the mid-1990's, dual-purpose closed-end mutual funds (CEFs) invested in a single securities portfolio. Then a second step occurred in which there were created a series of closed-end mutual funds that had differing rights and responsibilities with that single portfolio. The same process was used with closed-end funds overseas, as in England. Following a change in U.S. law (Tax Reform Act of 1986 (TRA '86)), no such funds were created in the U.S., Nearly four decades have passed, and no one invented a way to achieve what was terminated by TRA '86, until this invention. While dual-purpose closed-end funds once existed decades ago, not one operates in the U.S. today, and no one prior to this invention has found a way to accomplish what was done with dual-purpose closed end funds. The invention is unique in that it allows multi-purpose mutual funds to operate again because of the invention's mechanics, which are so different and opposite those that were terminated three decades ago in the U.S. and used in England. Unlike the closed-end funds in the U.S. and overseas, the invention's system, method and apparatus enable the invention to provide the first and only operational multi-purpose investment companies (ICs) serving multiple complementary objectives of separate ICs, so that they may create and invest their funds together in a single portfolio to serve their multiple complementary objectives.

Prior to this invention there have never been separate investment companies that join to invest in a single securities portfolio for the enhancement of complementary objectives. In one embodiment of the invention, one IC's objective is high and increasing actual money flows, while a complementary IC's objective is high increases in principal. Both objectives are to be achieved in a way that significantly reduces the range of risks to obtain each objective, while significantly increasing the likelihood of significantly greater expected returns for both of their respective objectives.

The present invention's system, method, and apparatus work in a manner unlike and opposite to the prior closed-end funds that have been extinct for more than a quarter century, or in use overseas. The invention brings together investment funds from two or more separately controlled investment companies that have complementary investment objectives. The invention then allocates unequally the features, risks, and obligations of a single portfolio in a manner that enhances the ability of the multiple ICs to achieve their complementary investment objectives.

A rigorous process for selection of professional portfolio managers is necessary to optimize the benefits and minimize the risks of the complementary objectives of the separately controlled investment companies. The invention is unique in combining a computer-driven rigorous system and method for selection of portfolio managers, which is not customary or conventional in portfolio manager selection. It is also unconventional to use this computer-driven rigorous system and method of portfolio manager selection with the cooperative investment in a single portfolio by separate investment companies with complementary objectives.

The instant inventor has built a new technical infrastructure of various specialized computers performing complex data aggregation, calculations, analysis, modeling, comparing, scoring and ranking, comprising one or more processors, one or more memories, including instructions executable by the one or more processors to cause the one or more processors to perform operations, described below.

The invention consists of computer processors, servers, display, and networked components to combine investments in a way that transforms their performance to significantly more returns. Using a novel, non-obvious, and useful system and method for investors, the invention transforms returns on ordinary investments, such as stocks and bonds. The invention significantly increases the probability of significantly exceeding normal returns without taking commonly associated levels of excessive credit risk or excessive leverage risk. By this process, embodiments of the invention: a) provide solutions to The Fixed Income Problem, b) provide immediate access to fiduciary-screened ICs (including but not limited to exchange traded funds), c) allow an income investor to realize capital gains on an income investment while retaining the income stream, and mitigate or solve many investment problems, including the other 6 described above.

### BRIEF DESCRIPTION OF THE DRAWINGS

The present disclosure may be better understood, and its numerous features and advantages made apparent to those skilled in the art, by referencing the accompanying drawings. The use of the same reference symbols in different drawings indicates similar or identical items.

FIG. 1 is a high-level diagram showing an example of a computer-driven system for transforming a portfolio of ordinary securities into a portfolio that generates significantly more returns with less risk, accomplished by TWO separate investment companies joining in the cooperative management of a single portfolio for extraordinary returns of the complementary objectives for each investment company, in accordance with some embodiments.

FIG. 1A is a high-level diagram showing an example of a system for transforming a portfolio of ordinary securities into a portfolio that generates significantly more returns with less risk, accomplished by THREE separate investment companies joining in the cooperative management of a single portfolio for extraordinary returns of the complementary objectives for each investment company, in accordance with some embodiments.

FIG. 1B is a high-level diagram showing an example of a system for transforming a portfolio of ordinary securities into a portfolio that generates significantly more returns with less risk, accomplished by FOUR separate investment companies joining in the cooperative management of a single portfolio for extraordinary returns of the complementary objectives for each investment company, in accordance with some embodiments.

FIG. 1C is a high-level diagram showing an example chart 100C of a system implementing a Data Input page for use by IC, in accordance with some embodiments.

FIG. 1D is a high-level diagram showing an example chart 100D of a system implementing a scoring and ranking output, based on the input factors illustrated in FIG. 1D, in accordance with some embodiments.

FIG. 2 shows an example of a computing system useable to implement some aspects of the present disclosure, in accordance with some embodiments.

FIG. 2A shows an example of a system for receiving proprietary and third-party data, analyzing and modeling with such data, generating outputs with rankings and user insights, and generating a graphical user interface according to some aspects of the present disclosure, in accordance with some embodiments.

FIG. 3 shows an example of a user workstation that may be used for each of the specialized computer functions, which may be one or more computer workstations for all specialized computer functions, in one or more locations, in accordance with some embodiments.

FIG. 4 is provided to document the enablement of results from the invention's use by showing a performance data table of actual returns of a live and actively managed portfolio; the table provides historical returns of one account managed by five portfolio management firms; the performance data provides a realistic basis for the assumptions used in the invention's performance scenarios that follow in FIGS. 5 through 13, in accordance with some embodiments.

FIG. 5 shows a hypothetical performance scenario for TWO ICs with complementary objectives, assuming a 10% annual total return, in accordance with some embodiments. FIG. 5 is a graphical representation of a portfolio that optimizes both actual money flows and actual increases in principal and is an example of a display from the invention's graphical user interface.

FIG. 6 shows a hypothetical performance scenario for TWO ICs with complementary objectives, assuming a 7% annual total return, in accordance with some embodiments. FIG. 6 is a graphical representation of a portfolio that optimizes both actual money flows and actual increases in principal and is an example of a display from the invention's graphical user interface.

FIG. 7 shows a hypothetical performance scenario for TWO ICs with complementary objectives, assuming a 13% annual total return, in accordance with some embodiments. FIG. 7 is a graphical representation of a portfolio that optimizes both actual money flows and actual increases in principal and is an example of a display from the invention's graphical user interface.

FIG. 8 shows a hypothetical performance scenario for THREE ICs with complementary objectives, assuming a 10% annual total return, in accordance with some embodiments. FIG. 8 is a graphical representation of a portfolio that optimizes both actual money flows and actual increases in principal and is an example of a display from the invention's graphical user interface.

FIG. 9 shows a hypothetical performance scenario for THREE ICs with complementary objectives, assuming a 7% annual total return, in accordance with some embodiments. FIG. 9 is a graphical representation of a portfolio that optimizes both actual money flows and actual increases in principal and is an example of a display from the invention's graphical user interface.

FIG. 10 shows a hypothetical performance scenario for THREE ICs with complementary objectives, assuming a 13% annual total return, in accordance with some embodiments. FIG. 10 is a graphical representation of a portfolio that optimizes both actual money flows and actual increases in principal and is an example of a display from the invention's graphical user interface.

FIG. 11 shows a hypothetical performance scenario for FOUR ICs with complementary objectives, assuming a 10% annual total return, in accordance with some embodiments. FIG. 11 is a graphical representation of a portfolio that optimizes both actual money flows and actual increases in principal and is an example of a display from the invention's graphical user interface.

FIG. 12 shows a hypothetical performance scenario for FOUR ICs with complementary objectives, assuming a 7% annual total return, in accordance with some embodiments. FIG. 12 is a graphical representation of a portfolio that optimizes both actual money flows and actual increases in principal and is an example of a display from the invention's graphical user interface.

FIG. 13 shows a hypothetical performance scenario for FOUR ICs with complementary objectives, assuming a 13% annual total return, in accordance with some embodiments. FIG. 13 is a graphical representation of a portfolio that optimizes both actual money flows and actual increases in principal and is an example of a display from the invention's graphical user interface.

### DETAILED DESCRIPTION

The embodiments of the present invention relate to a computer-driven system, method, and apparatus that transform the performance of a conventional portfolio of investments, producing significantly greater returns with reduced risk. Unlike conventional and customary approaches, the invention introduces a novel framework that enables all forms of investment companies (ICs), including but not limited to exchange traded funds (ETFs), closed-end funds (CEFs), open end mutual funds, partnerships, joint ventures, collaborative arrangements, trusts, and co-mingled investment vehicles, both domestic and foreign to the U.S., to participate in a cooperative process that yields enhanced financial outcomes. Through the invention's unique structure and mechanisms, the returns available to investors exhibit characteristics that are materially distinct from those of conventional investment products.

The invention addresses a longstanding problem in portfolio management: the lack of effective strategies for optimizing performance across separate investment companies with complementary objectives when investing in a single portfolio. The invention fills this void by enabling two or more investment companies with differing but complementary goals to jointly fund and manage a single securities portfolio, while unequally apportioning the returns, risks, and obligations among the participants. This approach allows each investment company to pursue its distinct objective more effectively, while leaving an optimized balance of investment returns to benefit its complementary counterpart.

A feature of the invention is the fiduciary due diligence process for a tradeable security. The fiduciary due diligence process is a rigorously selected portfolio management process implemented through a complex, computer-driven mechanism. This mechanism identifies and deploys the most suitable portfolio managers for a given combination of ICs' complementary objectives, ensuring that the management of the single, shared portfolio is continuously optimized for the distinct and complementary objectives of each participating investment company. This tailored approach significantly increases the potential for higher returns while simultaneously reducing risk compared to conventional and customary methods. Simultaneously, this fiduciary approach creates an immediately accessible and tradeable fiduciary-screened investment company (IC), including but not limited to exchange traded funds (ETFs), closed-end funds (CEFs) and open-end mutual funds. The invention's practical application is particularly relevant for institutional fiduciary investors and the broader investing public. It addresses three persistent challenges. First is the Fixed Income Problem, where cash flows fail to keep pace with inflation, leading fiduciaries to pursue higher-risk investments that offset the loss of buying power in fixed income securities. Second is the need to provide “off the shelf” investment structures made for fiduciaries, to provide timely and immediate access to ICs including, but not limited to, exchange traded funds, closed-end funds, and mutual funds. The invention's process integrates a fiduciary-first approach, delivering a best-in-class fiduciary standard through every step of the investment lifecycle. Third is the ability for income-oriented investors to sell a security's capital gains while retaining the income stream of their original investment. Several other problems are addressed by the invention, including the six described earlier in the disclosure.

This combination, solving the Fixed Income Problem while preserving fiduciary integrity, and allowing the realization of capital gains while retaining an income stream, is both novel and unconventional. It reflects a unified solution that would be seen as surprising and valuable by those skilled in the art of portfolio management.

Through the use of a computer-driven structure, the invention introduces a set of transformative and non-conventional processes that generate investment outcomes otherwise unattainable through traditional methods. The system implements innovative fiduciary mechanisms and incorporates a number of features not previously combined in this domain. For example, the invention provides solutions for fiduciary investors through a single embodiment that (a) produces a continually increasing stream of returns; (b) reduces the need to assume higher levels of risk; (c) offers investments with returns similar to the current range of risky investments, but with lower levels of risk and (d) operationalizes a full fiduciary process that is immediately available for investors.

Furthermore, the invention introduces structures not found in the field of investment management. No known investment companies with differing objectives cooperatively invest in a single portfolio. No such companies apportion returns, risks, and obligations unequally to optimize distinct performance goals. Some embodiments even enable the realization of a high-return investment company's capital gains without disturbing the cash flows, a configuration that is entirely novel. Additionally, no prior art reflects a fiduciary investment process used for portfolio manager selection that incorporates security-level behavior analysis and stress testing at both single-manager and multi-manager levels. The invention evaluates combinations of portfolios, ranks them according to the objectives of the participating ICs, and identifies optimal configurations through a sophisticated, computer-driven analysis.

Each of these features is individually novel and non-obvious, and they must be implemented in a comprehensive computer-based system and method that represents a non-generic, unconventional solution to three persistent market problems. The system does not reflect standard industry practice and is directed to a specific, practical application within the field of portfolio management. The invention, therefore, represents a meaningful advancement in investments, portfolio optimization, and fiduciary practice.

The embodiments described herein illustrate processes to enhance the main investment objective of each investment company, thereby reducing the negative impact of common risks required to obtain each investment company's investment objective. The investment companies (ICs) in this invention include, but are not limited to, Exchange Traded Funds (ETFs), open-end mutual funds, closed-end funds (CEFs), unit investment trusts (UITs), collective investment trusts (CITs), registered investment companies (RICs), offshore trusts, other trusts, partnerships, and commingled investment vehicles. For the sake of brevity, in this disclosure and claims, “ICs” is used as a shorthand label to include, but not be limited to, all the previous investment possibilities listed in the previous sentence. For example, the invention disclosure's use of the term “IC” includes, but is not limited to, ICs and other investment vehicles such as offshore trusts, collective investment trusts, as well as private investment vehicles that are not publicly traded.

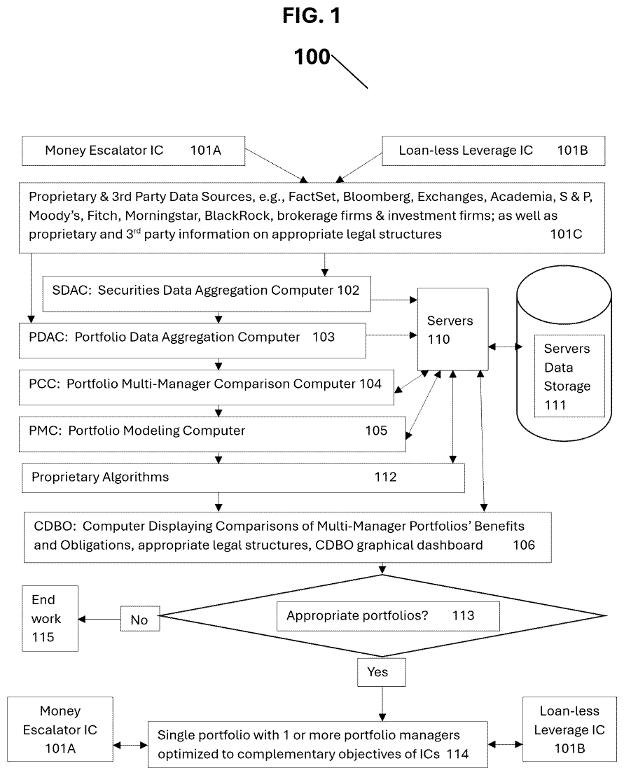

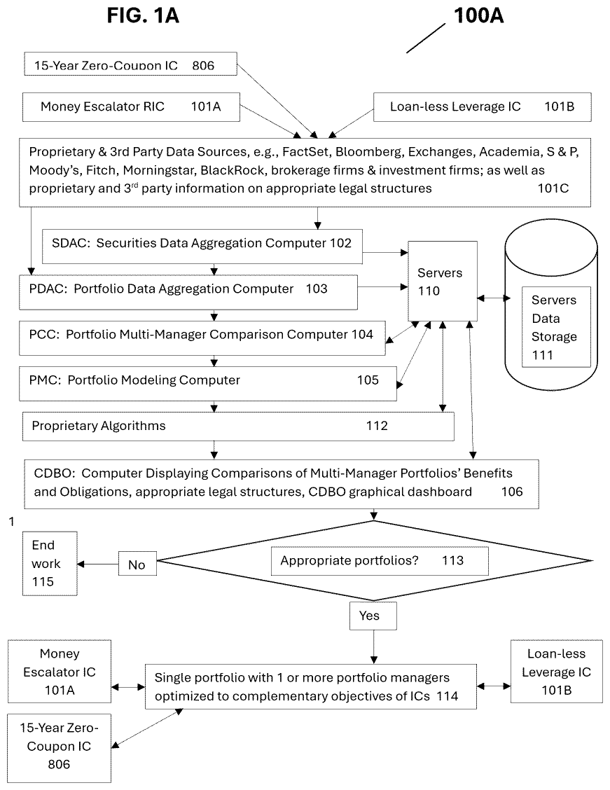

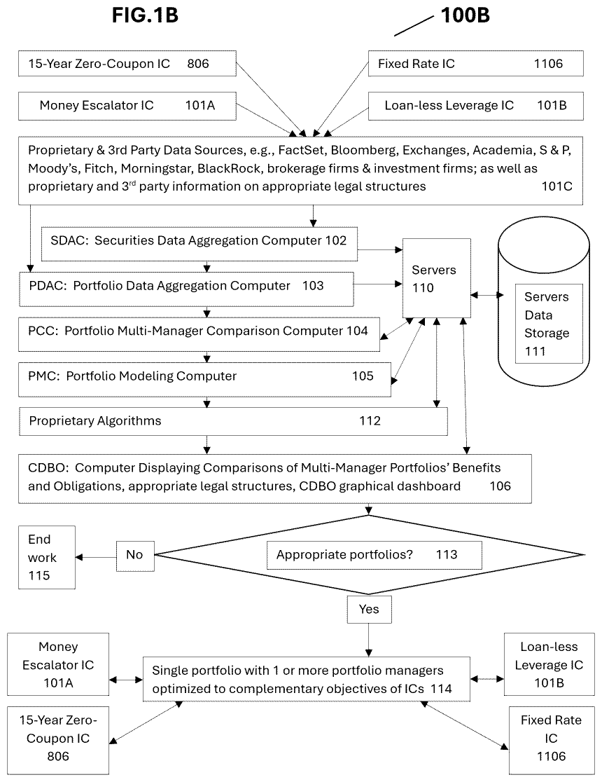

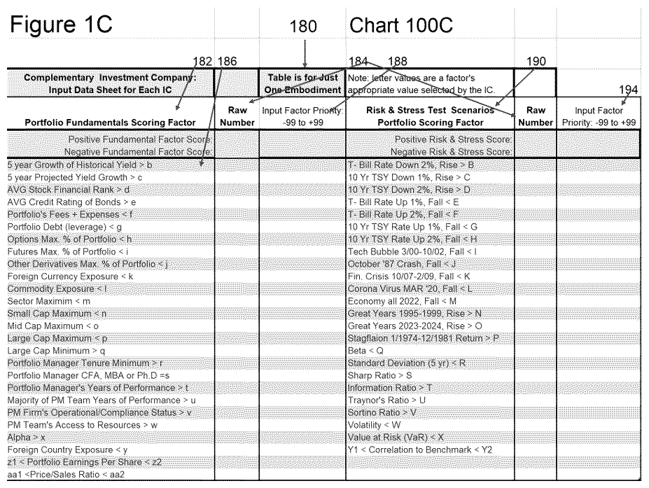

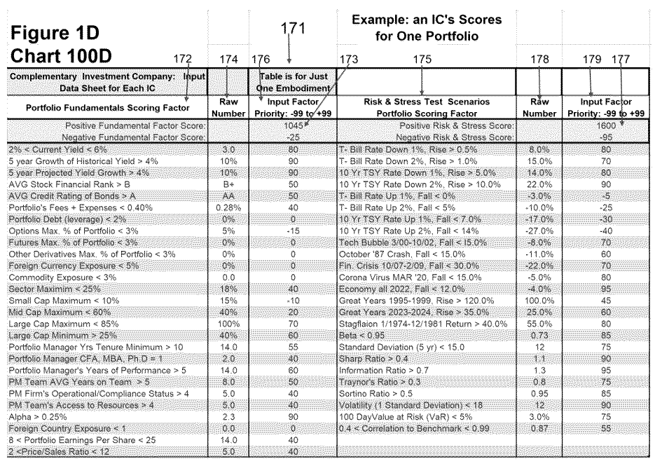

FIG. 1, FIG. 1A, and FIG. 1B illustrate three embodiments of the computer-driven invention, exemplifying the invention's logic of the system and method that provide improvements to portfolio manager selection, along with the use of a single portfolio of investments to optimize the complementary objectives of each investment company.

FIG. 1 is a high-level diagram showing an example of a system for transforming a portfolio of ordinary securities into a portfolio that generates significantly more returns with less risk, accomplished by TWO separate investment companies joining in the cooperative management of a single portfolio for extraordinary returns of the complementary objectives for each investment company, in accordance with some embodiments. FIG. 1 illustrates an embodiment of a computer-implemented portfolio construction and optimization system 100 configured to identify and rank investment portfolios that are optimized to satisfy complementary investment objectives of distinct investment companies (ICs). As depicted, the system receives data inputs from two example IC profiles, Money Escalator IC 101A and Loan-less Leverage IC 101B, each representing a different set of objectives. These IC profiles are connected to a data aggregation block 101C, which consolidates information from both proprietary and third-party data sources. These sources may include financial data providers (e.g., FactSet, Bloomberg), market exchanges, academic research, rating agencies (e.g., Moody's, S&P, Fitch), firms such as Morningstar and BlackRock, brokerage and investment firms, as well as legal and regulatory data repositories. The aggregated data may include historical and real-time market information, performance benchmarks, credit ratings, risk metrics, and guidance on appropriate legal structures for investment entities.

The data from block 101C is transmitted to the Securities Data Aggregation Computer (SDAC) 102, which is responsible for receiving and standardizing security-level data. From SDAC 102, the data flows to the Portfolio Multi-Manager Comparison Computer (PCC) 104, where security-level details are combined with portfolio data and compiled into portfolio-level datasets. PDAC 103 is responsible for receiving and standardizing data on existing portfolios managed by a range of portfolio managers, and performs operations such as calculating aggregate risk metrics, fees, historical returns, and portfolio composition statistics. These datasets are then passed to the Portfolio Multi-Manager Comparison Computer (PCC) 104, which aggregates the data, and evaluates and compares multiple portfolios managed by different investment managers. PCC 104 identifies complementarities and trade-offs among portfolios, allowing the system to assess whether combining multiple managers or investment strategies would result in a more aligned and optimized portfolio given the ICs' distinct and complementary objectives.

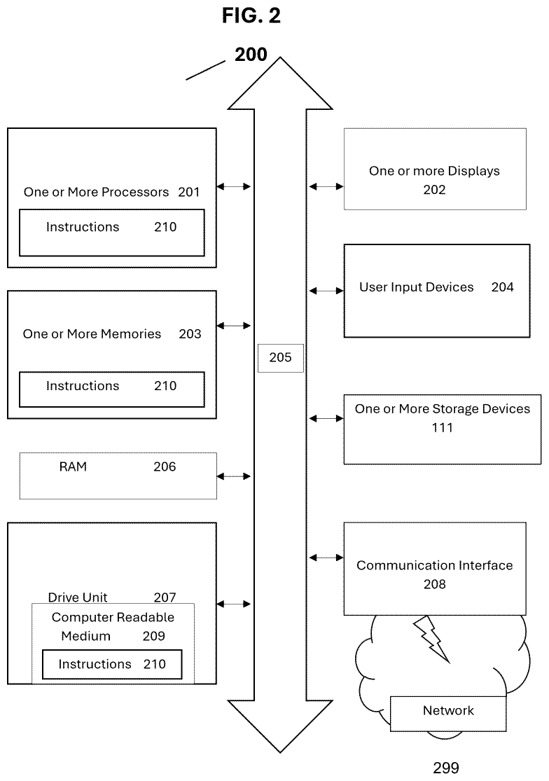

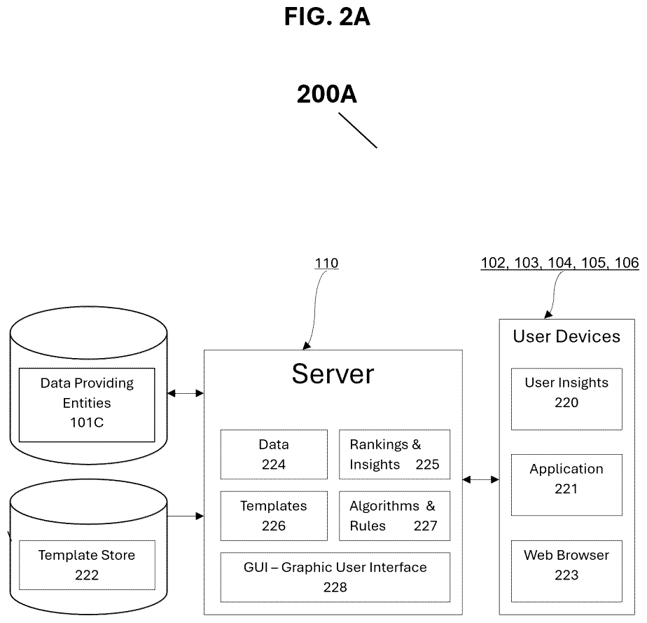

The processed data is further refined by the Portfolio Modeling Computer (PMC) 105, which generates hypothetical or modified portfolio models based on the comparative outputs and input parameters. Portfolio Modeling Computer (PMC) 105 aggregates the candidate portfolio managers' securities investments from PCC 104 and provides a multitude of possible multi-manager combined portfolios yielding an output, employing rules and algorithms 227 (FIG. 2A) to rank those with the most optimal performance for the complementary objectives of IC 101A and IC 101B, usings its graphical tool to display 202 (FIG. 2) outputs. These modeled portfolios are then evaluated using proprietary algorithms 112 that perform scoring, ranking, and optimization computations. The algorithms assess each portfolio configuration for alignment with the ICs' defined objectives, constraints and preferences. The results of this evaluation are then displayed on a graphical dashboard via the Computer Displaying Comparisons of Benefits and Obligations in Multi-Manager Portfolios (CDBO) 106. The CDBO provides a visual comparison of candidate portfolios, including their associated benefits, obligations, legal structure suitability, and alignment with multi-manager strategies.

At decision node 113, the system determines whether one or more portfolios meet the criteria established by the ICs. If no suitable portfolios are identified, the process may terminate at end node 115. If appropriate portfolios are found, the system proceeds to generate a final output in block 114. This output comprises a ranked set of single portfolios, potentially managed by one or more portfolio managers, ranked by the way each portfolio is optimized to simultaneously fulfill the differing yet complementary objectives of the participating ICs. The system architecture also includes backend infrastructure, including servers 110 and data storage 111, which support data persistence, computational scalability, and regulatory recordkeeping. Overall, system 100 provides a comprehensive platform for data-driven portfolio construction, multi-manager comparison, and legal-structure-aware investment optimization.

In this embodiment of the system, method, and apparatus illustrated in FIG. 1, diagram 100, two investment companies (ICs), 101A and 101B, interact with computer networks to access information from external databases 101C. These databases provide the historical behavior of individual securities, which is then gathered and aggregated by the Securities Data Aggregation Computer (SDAC) 102. The SDAC 102 functions as a securities data processing engine and may include a graphical display tool 202 (FIG. 2) to present the results. Specifically, SDAC 102 is configured to access internet-connected databases and aggregate data from multiple external computers, retrieving information in various formats that pertain to the complementary investment objectives of the ICs. It obtains data from one or more securities data sources on securities whose characteristics align with the optimization of actual money flows. These characteristics may include, but are not limited to, current yield, compound annual growth rate (CAGR) of yield, R², S&P rankings, debt ratio, standard deviation, Sharpe ratio, Traynor ratio, and earnings-per-share (EPS) CAGR. Additionally, SDAC 102 retrieves information from one or more securities exchanges or other sources on securities that may optimize both actual money flows and principal appreciation, relying on similar metrics.

The Portfolio Data Aggregation Computer (PDAC) 103 enables IC 101A and IC 101B to further access computer networks to collect and consolidate data on actively managed investment portfolios. The PDAC 103 operates a portfolio-level aggregation system that gathers data on the full holdings within existing portfolios, and it includes graphical display tools 202 for visualizing the output. This module applies the characteristics of the individual securities, previously identified by the SDAC 102, to the portfolios' holdings. Furthermore, PDAC 103 incorporates performance outcome data derived from various stress-testing and modeling scenarios. These outcomes assess how portfolio characteristics contribute to financial objectives such as optimizing money flows and achieving increases in principal. Evaluated characteristics may include but are not limited to CAGR, current yield, yield CAGR, volatility, beta, alpha, correlation to benchmark indices, inter-portfolio correlation, Sharpe ratio, Traynor ratio, standard deviation, R², as well as metadata related to the portfolio managers, such as their tenure, credentials, and historical performance

The Portfolio Multi-Manager Comparison Computer (PCC) 104 receives and processes the aggregated data from both the SDAC 102 and PDAC 103. It applies these data sets to enable comparative analysis of candidate portfolios and portfolio managers. The PCC 104 utilizes graphical tools 202 to present its outputs, allowing ICs 101A and 101B to evaluate a preliminary selection of the most promising candidates for investment management, whether structured under a single manager or distributed across multiple managers. The PCC 104 performs integrated analysis of the portfolios' security-level characteristics obtained from SDAC 102, combined with manager-level data compiled by PDAC 103, including but not limited to each manager's credentials, such as tenure, performance track record, and educational background. The comparative outputs support informed decision-making on portfolio selection and manager assignment in accordance with each IC's investment priorities. In FIG. 1 further greater detail is provided in 100, continuing the system, method, and apparatus' process with each computer's graphical display tool 202 showing outputs that have alternative weightings of combinations of portfolio managers' portfolios, along with the proprietary algorithms' 227 rankings 225 of the single and combined portfolios based on their ability to serve the complementary objectives of the ICs. Are there one or more beneficial portfolios for the ICs complementary objectives? If no portfolio or combination of portfolios sufficiently serves the complementary objectives of the ICs, then the process ends 115. Should there be a portfolio or combination of portfolios to serve the complementary objectives of the ICs, then the process continues with the CDBO as described at length in FIG. 1. CDBO 106, where data for single portfolios, and multiple portfolio managers' portfolio combinations, are combined with the complementary objectives, cooperative operational parameters, and legal structures for the multiple ICs to work together. Output data is shown on its graphical display tool 202.

Again, are there one or more combinations of all these requirements and parameters 113 that provide significantly better performance for the ICs? If not, then the system, method, and apparatus' process end 115. If yes, then the next step is for the ICs to sign all agreements, hire the portfolio manager(s), and invest in the single portfolio 114 in the agreed upon proportions 114 and contractual terms.

FIG. 1A is a high-level diagram showing an example of a system for transforming a portfolio of ordinary securities into a portfolio that generates significantly more returns with less risk, accomplished by THREE separate investment companies joining in the cooperative management of a single portfolio for extraordinary returns of the complementary objectives for each investment company. FIG. 1A illustrates an embodiment of a multi-stage, computer-driven portfolio construction and optimization system 100A, designed to generate a single optimized portfolio that satisfies the complementary investment objectives of multiple investment companies (ICs). In this example, the system receives discrete investment mandates from three distinct ICs, a Money Escalator IC 101A, a Loan-less Leverage IC 101B, and a 15-Year Zero-Coupon IC 806, each reflecting different portfolio preferences, such as income generation, low leverage exposure, and long-term compound fixed-income returns, respectively. These ICs interface with a central data aggregation module 101C, which receives proprietary and third-party information from financial data services (e.g., FactSet, Bloomberg), public exchanges, academic sources, ratings agencies (e.g., Moody's, S&P, Fitch), and investment platforms such as Morningstar and BlackRock. The data may include performance metrics, instrument classifications, credit ratings, market indices, brokerage feeds, and legal structure details for fund design and compliance.

The aggregated data is transmitted to a Securities Data Aggregation Computer (SDAC) 102, which processes and normalizes security-level information, including historical pricing, volatility, ratings, and sector classification. The output of SDAC 102 flows into a Portfolio Data Aggregation Computer (PDAC) 103, where individual securities are aggregated into portfolio-level representations for each manager or strategy under consideration. PDAC 103 analyzes the aggregated portfolios for characteristics such as sector exposure, market capitalization, management fees, and performance history. The system then utilizes a Portfolio Multi-Manager Comparison Computer (PCC) 104 to compare and contrast portfolios managed by different advisors. PCC 104 identifies overlaps, diversification patterns, or inefficiencies in order to guide potential multi-manager solutions that align with each IC's objective.

The Portfolio Modeling Computer (PMC) 105 receives the output from PCC 104 and PDAC 103 to generate modeled portfolios tailored to the input criteria of the ICs. These models simulate performance under various constraints, including legal structure compatibility, tax efficiency, regulatory rules, and manager capacity. The modeled portfolios are then evaluated using proprietary algorithms 112, which score and rank each configuration based on how well it satisfies the ICs' investment goals, risk parameters, and operational constraints. The results are presented via a Computer Displaying Comparisons of Benefits and Obligations in Multi-Manager Portfolios (CDBO) 106, which provides a graphical dashboard displaying the relative advantages, obligations, and legal compliance status of each potential portfolio. At decision node 113, the system determines whether any of the modeled portfolios meet the complementary objectives of all participating ICs. If no portfolio is deemed appropriate, the process terminates at end node 115. If one or more portfolios are deemed suitable, the system selects and outputs a single optimized portfolio at block 114. This recommended portfolio may be jointly managed and is designed to simultaneously optimize the distinct goals of the Money Escalator IC 101A, the Loan-less Leverage IC 101B, and the 15-Year Zero-Coupon IC 806. The entire system is supported by backend computing infrastructure, including servers 110 and data storage 111, which facilitate high-speed data access, model persistence, and long-term archival of analysis workflows and outcomes.

FIG. 1B is a high-level diagram showing an example of a system for transforming a portfolio of ordinary securities into a portfolio that generates significantly more returns with less risk, accomplished by FOUR separate investment companies joining in the cooperative management of a single portfolio for extraordinary returns of the complementary objectives for each investment company. FIG. 1B illustrates a further embodiment of a computer-implemented system 100B configured to construct and optimize a single investment portfolio that optimizes the complementary objectives of multiple investment companies (ICs). In this configuration, the system supports inputs from a broader set of participating ICs, including a Money Escalator IC 101A, a Loan-less Leverage IC 101B, a 15-Year Zero-Coupon IC 806, and a Fixed Rate IC 1106. Each of these ICs has distinct and complementary investment objectives, such as capital appreciation, low-leverage structuring, fixed-income positioning, and long-duration bond holdings, which may be mutually exclusive or partially aligned. The system receives these objectives as input and processes them through an integrated multi-computer architecture.

The system receives data inputs from a range of proprietary and third-party data sources, collectively referenced as block 101C. These sources include financial market data providers (e.g., FactSet, Bloomberg), trading exchanges, academic research, and institutional services such as those offered by Moody's, S&P, Fitch, Morningstar, BlackRock, and various brokerage or investment firms. The data may include pricing history, risk profiles, credit ratings, macroeconomic indicators, portfolio manager performance records, and structural information relevant to the formation of compliant and optimized investment products.

This input data is first processed by the Securities Data Aggregation Computer (SDAC) 102, which aggregates and standardizes security-level information across asset classes. SDAC 102 identifies key characteristics such as yield, duration, volatility, and credit rating for each security, and feeds this standardized dataset into the Portfolio Data Aggregation Computer (PDAC) 103. PDAC 103 compiles and formats these security-level inputs into portfolio-level datasets, constructing representative models of investment manager strategies or historical performance compositions for each IC's investment objectives.

The aggregated portfolio data is then analyzed by the Portfolio Multi-Manager Comparison Computer (PCC) 104, which performs multi-dimensional comparisons between portfolios managed by different asset managers. PCC 104 evaluates metrics such as diversification, redundancy, risk-adjusted return, manager correlation, and cost efficiency to identify combinations that may serve the collective interests of the participating ICs. These findings are transferred to the Portfolio Modeling Computer (PMC) 105, which simulates portfolio constructions that incorporate one or more managers, constrained by parameters specific to each IC's strategy.

The PMC's output is then evaluated by a set of proprietary algorithms 112 that rank, score, and filter the modeled portfolios based on how effectively they satisfy the complementary goals of the ICs. These algorithms may use objective functions that balance competing criteria such as return maximization, volatility minimization, fee reduction, legal compliance, and leverage exposure. The results are then visualized using the Computer Displaying Comparisons of Benefits and Obligations in Multi-Manager Portfolios (CDBO) 106. The CDBO dashboard provides a graphical output of candidate portfolios, showing trade-offs in manager selection, projected returns, regulatory implications, and legal structuring.

At decision node 113, the system determines whether one or more of the modeled portfolios meet the criteria set forth by the combination of ICs. If the system determines that no viable portfolio exists, the process is terminated via end node 115. If one or more candidate portfolios are found to satisfy the full set of complementary IC requirements, the system advances to block 114, which generates a final portfolio recommendation. The resulting portfolio is structured with one or more portfolio managers and is designed to optimized each of the distinct and complementary objectives of the Money Escalator IC 101A, the Loan-less Leverage IC 101B, the 15-Year Zero-Coupon IC 806, and the Fixed Rate IC 1106. Throughout this process, servers 110 and data storage infrastructure 111 facilitate the storage, retrieval, and real-time processing of historical, modeled, and prospective portfolio configurations, thereby enabling system 100B to dynamically construct legally compliant and performance-optimized investment solutions.

As noted above, FIG. 1 shows one embodiment as an example of a system and method 100 for enhanced portfolio manager selection and its utilization in a single portfolio in which investments are made by multiple ICs with complementary objectives. In the investment management industry, it is unconventional and not customary to select portfolio managers in the system and method of the present invention. This embodiment of the invention's system and method 100 is configured with one or more servers 110 and user devices 102, 103, 104, 105, and 106. The servers 110 may be servers of a service provider or servers of the users. The servers 110 are also configured to store and manage data, as well as user inputs, including but not limited to instructions, criteria, parameters, and insights of users in 102, 103, 104, 105, and 106.

FIG. 1C is a high-level diagram illustrating an example chart 100C of a system implementing a Data Input page for use by an investment company (IC), in accordance with some embodiments. The Data Input page allows the IC to enter, manage, and transmit financial parameters, investment objectives, and strategy-related data into the system to support coordinated portfolio management. FIG. 1C illustrates an embodiment of a graphical user interface (GUI) 180 configured as a structured data input page of a portfolio scoring and comparison system for use by an investment company (IC). This interface, referenced as Chart 100C, facilitates user input of both quantitative metrics and prioritization weights associated with portfolio fundamentals and stress test scenario responses. The GUI is divided into two primary input panels: a Portfolio Fundamentals Scoring Factor input region 182 and a Risk & Stress Test Scenarios Portfolio Scoring Factor input region 190. Each region is organized into multiple columns that accept, respectively, a factor description, a raw numerical value 184 represents an observed or calculated metric, and a corresponding input priority value 188 or 194 that may range from −99 to +99. The priority value enables the IC to modulate the relative influence of each factor or scenario within the broader scoring algorithm.

The Portfolio Fundamentals Scoring Factor input region 182 includes fields for entering data associated with key performance indicators 186, such as the five-year growth of historical yield, average stock financial rating, credit rating of bond holdings, portfolio fees and expenses, leverage ratios, and allocations across market capitalization segments (e.g., small-cap, mid-cap, and large-cap holdings). Additional fields support input for qualitative or credential-based metrics such as portfolio manager tenure, educational credentials (e.g., CFA, MBA, or Ph.D.), and firm-level indicators like compliance status and access to resources. Some entries correspond to mathematical expressions or conditions, such as “Portfolio's Fees+Expenses <f” or “Alpha>x”, indicating that the metric must be compared to a threshold or benchmark value.

The Risk & Stress Test Scenarios input region 190 allows the user to input data concerning the portfolio's sensitivity or projected response to macroeconomic changes and historical event simulations. These include hypothetical interest rate movements 192 (e.g., “T-Bill Rate Down 1%, Rise>0.5%”), market crash analogues (e.g., “October '87 Crash, Fall<J”), historical recovery periods (e.g., “Great Years 1995-1999, Rise>N”), and volatility-based performance metrics such as beta, standard deviation, Sharpe ratio, Sortino ratio, and Value at Risk (VaR). Each scenario is associated with a raw numerical response value and a priority factor, enabling the system to dynamically weight scenario impacts in accordance with institutional investment philosophy or risk posture.

A header row across both panels provides context for each column and includes explanatory notes indicating that letter values (e.g., a, b, c, etc.) serve as variable placeholders or thresholds configured by the IC. The interface supports both manual data entry and automated system integration, allowing raw numbers and priority values to be entered directly or imported from external databases or data feeds. In operation, the interface shown in FIG. 1C enables the systematic entry and prioritization of portfolio and stress test data, supporting subsequent computation of comparative portfolio scores and risk-adjusted investment performance metrics within the system.

FIG. 1C of Chart 100C further illustrates an embodiment of the input by each IC, with examples of the data's priority scoring of over 50 factors, most of which involve complex calculations, that are the basis for the computer-implemented output of rankings and comparisons of candidate portfolios and combinations of portfolios that best achieve the very different and complementary objectives of each IC. The embodiment of IC input for data scoring includes scoring for characteristics to avoid (negative scores) that may be ranked separately from the characteristics that are favorable in achieving the IC's objectives. Note that in the Stress Tests, the current portfolio holdings gathered in the PDAC 103 are used in creating the stress scenarios, i.e. the stress tests are not the historical performance of past portfolios during past events. For example, in the March 2000 to October 2002 market collapse known as the Tech Bubble, the economic and market characteristics of March 2000 are used with the current portfolios' securities holdings, using securities data gathered by the SDAC 102, to generate the level of down movement of the current portfolio in such circumstances. The same treatment is used with benchmark indices (e.g., S&P 500), where current securities in the index, using securities data gathered by the SDAC 102, are used in circumstances of the past.

FIG. 1C further illustrates the large number and variety of factors that may be used and is not limiting or restricting factors or ratings that may be used. The letters (a to aa, and A to Y) are where the IC inserts the appropriate values to score for the achievement of their objectives. Outcome data of the PCC 104 pertains to those portfolios' performance produced by the various characteristics of the portfolios, such as those that simultaneously optimize actual money flows and actual increases in principal, while including but not limited to other characteristics such as EPS, CAGR, current yield, yield CAGR, volatility, beta, alpha, correlation to various indices, correlation to each other, Sharpe ratio, Traynor ratio, standard deviation, R², and the tenure, performance data, and credentials of each portfolio manager.

FIG. 1D is a high-level diagram chart 100D that shows an example of a system implementing a scoring and ranking output, based on the input factors illustrated in FIG. 1C. FIG. 1D of Chart 100D illustrates an embodiment of a data input interface 171 configured for use by an investment company (IC) to define scoring priorities and raw factor values for a portfolio analysis and comparison system. The system is designed to support the evaluation, ranking, and comparison of candidate portfolios and combinations of portfolios that most effectively fulfill the differing and complementary objectives defined by each IC. In the illustrated embodiment, the interface provides structured input for over fifty scoring factors, each of which may involve complex calculations or condition-based determinations based on live portfolio holdings, proprietary data, or third-party analytics.

The data input interface includes two principal sections: a Portfolio Fundamentals Scoring Factor input panel 172 and a Risk & Stress Test Scenarios Portfolio Scoring Factor input panel 175. Each scoring factor row includes a raw numerical input value 174 or 178 and an associated priority weighting value 176 or 179. The priority input value, which may range from −99 to +99, allows the IC to specify the strategic significance of each factor within their individualized portfolio scoring methodology. The scoring systems 173 and 177 accommodate both positive characteristics, which support the IC's objectives, and negative characteristics, which are to be avoided or minimized. Notably, the system supports independent scoring of positive and negative attributes, allowing more nuanced portfolio assessments.

As shown in the embodiment of FIG. 1D, the Portfolio Fundamentals section 172 includes factor categories such as current yield (e.g., “2%<Current Yield<6%”), growth in yield, credit rating thresholds (e.g., “AVG Credit Rating of Bonds>A”), portfolio expenses (e.g., “<0.40%”), leverage, allocation across market capitalizations, and portfolio manager characteristics (e.g., tenure, credentials, access to resources). These factors are entered via raw data fields 172 and are weighted using corresponding priority inputs 173 provided by the IC. Symbolic notation (e.g., a to aa) is used in association with each factor to allow customizable reference values or relational expressions.

The Risk & Stress Test Scenarios section 175 facilitates input of expected portfolio performance under forward-looking stress conditions. Unlike conventional historical back testing, the stress test system applies historical macroeconomic conditions (e.g., from the March 2000 to October 2002 “Tech Bubble” or the 2020 COVID-19 market dislocation) to the IC's current portfolio holdings, using securities data gathered by the SDAC 102 and portfolio data gathered by the PDAC 103. For example, in simulating the Tech Bubble collapse, the system utilizes the actual financial conditions present in March 2000, but recalculates risk exposure and drawdown potential using the IC's current asset allocations and security mix. This methodology is extended to benchmark simulations (e.g., S&P 500), wherein the scenario inputs are applied to the current constituents of the index, rather than to historical constituents, providing forward-relevant, portfolio-specific insight.

Each stress test scenario is associated with a projected portfolio response (e.g., percentage decline or volatility score), entered as a raw number 176, and a priority weight 177 indicating the IC's sensitivity to such risks. Example factors include interest rate shifts (e.g., “T-Bill Rate Down 1%, Rise>0.5%”), event-driven simulations (e.g., “October '87 Crash”), and performance metrics (e.g., “Sharpe Ratio>0.4”, “Sortino Ratio>0.5”, “Value at Risk<5%”). An example data table 174 provides numerical context for the IC's scoring entries, as shown under column headers aligned with factor inputs.

The embodiment of FIG. 1D is not limiting with respect to the number or nature of input factors, stress scenarios, or scoring methodologies that may be employed. The chart demonstrates a flexible, extensible architecture that accommodates the insertion of IC-specific values (e.g., thresholds, ranges, scoring rules) into designated input fields. Letters (e.g., a through aa; A through Y) serve as placeholder variables corresponding to configurable factor thresholds and scenario conditions.

In aggregate, the interface shown in FIG. 1D allows for comprehensive, IC-tailored data entry to guide a computer-driven scoring engine in producing multi-factorial rankings and comparative outputs. The result is a transformative individualized system for portfolio assessment, enabling each IC to algorithmically determine which portfolio configurations most effectively support their strategic investment objectives. The example shown in region 179 further illustrates an IC's score page for one portfolio, where the combined output of the raw inputs and priority values is used to generate total scores (e.g., 1045 in field 174 and 1600 in field 178), reflecting the system's aggregation and computational scoring logic.

There are many ways to perform comparisons of portfolios. In Chart 100D a version of many possible scoring systems shows one example in which each factor input in the computer program is to provide a measure of the importance of each factor toward achieving the IC's objectives. For example, if the IC seeks high and continually rising money flows, then in “Current Yield>a” there would be multiple possible priority scores. If a=2.5%, then a 2.4% current yield of the portfolio may receive “−10”, 2.8% receive 30, and a 3.0% receive 60. However, a current yield of 7% may receive a −20 as it indicates financially risky stocks of companies having business difficulties. Such rating numbers are part of the computer program input, and each factor must be considered separately. Each of the more than 50 factors has this sensitivity built into the computer program. It is important to recognize that quantitative differences in a factor actually are qualitative differences in the portfolio's behavior, which become qualitative differences in practical application. In the “Current Yield” case of money flows, an increase from 2.4% to 3.0% is a 25% pay raise, which is large enough to substantially improve someone's life. For each of the more than 50 factors, the priorities' scoring output may be viewed on the graphic user interface 202, if the user so desires, though this is not necessary. Each portfolio will show how it is scoring on all factors, as scored using the computer program.

In the embodiment illustrated in FIG. 1D, the Portfolio Modeling Computer (PMC) 105 generates output for combinations of multi-manager portfolios that may contain several hundred securities. These outputs can be displayed in a table formatted similarly to Chart 100D shown in FIG. 1D. The PMC 105 receives aggregated input data from the Portfolio Multi-Manager Comparison Computer (PCC) 104 and conducts performance analyses across a variety of historical and comparative metrics. These metrics include, but are not limited to, actual cash flow growth, increases in principal value, earnings per share compound annual growth rate (EPS CAGR), current yield, yield CAGR, volatility, beta, alpha, correlation to relevant market indices, intra-portfolio correlations, Sharpe ratio, Treynor ratio, standard deviation, R² values, as well as tenure, performance, and educational background of portfolio managers. Using this data, the PMC applies proprietary algorithms and rules (e.g., 227) to rank various combinations of portfolios and identify those that demonstrate the most optimal performance outcomes with respect to the complementary investment objectives of IC 101A and IC 101B. These outcomes are dynamically presented through a graphical interface that visually displays ranked outputs 202.

In one embodiment, as reflected in the data shown in FIG. 1D, the PMC's computer-driven ranking system enables a graphical user interface to display composite scores including positive totals, negative totals, or combinations thereof, including all four score categories. The system also supports the display of sub-category scores grouped by factor types or thematic attributes. Computer templates and commercial data services may be used to supply the raw data and performance summaries that underpin this scoring and ranking process. However, it is notable that prior to the present invention, such templates and services were not used in the context of selecting portfolio management firms based on performance scoring and ranking. The use of a computer-driven system to identify, evaluate, and select portfolio managers through data aggregation, scoring, and comparative analytics is unconventional, novel, and non-obvious within the industry.

Further, the system incorporates a Computer Displaying Comparisons of Multi-Manager Portfolios' Benefits and Obligations (CDBO) 106, which gathers and aggregates the PMC outputs and compares the most optimal portfolio configurations. These configurations may involve a single manager or multiple managers and are rendered on a graphical user interface 202 that may use the same visual structure as FIG. 1D, Chart 100D. The CDBO 106 is also linked to internet-based legal data sources 101C, which supply information regarding legal frameworks that support cooperative operations among multiple ICs. This includes, but is not limited to, potential legal structures such as management agreements, limited partnerships, joint ventures, collaborative operating agreements, domestic trusts, and offshore trusts. The CDBO 106 integrates these legal considerations with portfolio configuration outputs, including the implications of various ICs investing at different percentages in a shared portfolio, and proposes legally viable structures to facilitate cooperative investment by multiple ICs in a single portfolio 114.

FIG. 2 illustrates a block diagram of an example computing system 200 that may be utilized to implement any of the computer-based modules, functions, or algorithms described in the portfolio optimization and multi-IC integration systems of the preceding figures. The system 200 represents a generic computing architecture that may be integrated into one or more components such as the Securities Data Aggregation Computer (SDAC), Portfolio Data Aggregation Computer (PDAC), Portfolio Comparison Computer (PCC), Portfolio Modeling Computer (PMC), or the Computer Displaying Comparisons (CDBO), as described in FIGS. 1 through 1B.

The system 200 includes one or more processors 201, which may be implemented as a central processing unit (CPU), a digital signal processor (DSP), a graphics processing unit (GPU), an application-specific integrated circuit (ASIC), a field-programmable gate array (FPGA), or any combination thereof. The processors 201 execute machine-readable instructions 210 stored in one or more memories 203, which may include volatile memory such as RAM 206, and non-volatile storage such as read-only memory (ROM), flash memory, or magnetic storage devices.

The computing system also includes one or more displays 202 to present information to a user, such as a graphical user interface (GUI), dashboards, or real-time feedback regarding portfolio selection, stress test results, or scoring metrics. In conjunction with the display, the system may include one or more user input devices 204 (e.g., a keyboard, mouse, touch-sensitive surface, voice input, or sensor-based input), which enable the user to interact with and control the system. These elements may be integrated into a workstation terminal, remote computing environment, or web-based platform.

A system bus 205 facilitates communication between internal components, including the processor(s), memory, and other subsystems. One or more storage devices 111 are coupled to the system to provide persistent data storage for application state, reference data, models, compliance rules, and regulatory archives. These may include hard disk drives (HDD), solid-state drives (SSD), or remote storage accessed through network protocols.

The system 200 also includes a drive unit 207 configured to read instructions 210 from a non-transitory computer-readable medium 209. This medium may include optical storage, magnetic tape, or a flash memory module used for deploying software applications, boot loading processes, or module updates. The drive unit facilitates execution of machine-readable code that implements the proprietary algorithms used in modeling and optimization workflows described previously.

A communication interface 208 enables the computing system 200 to exchange data with external devices, data sources, or servers across a network 250. The communication interface may support wired (e.g., Ethernet) or wireless (e.g., Wi-Fi, LTE, 5G) protocols, and may include encryption and authentication functions for secure data transfer. The system may be distributed, virtualized, or cloud-hosted, with network 250 representing local area networks (LAN), wide area networks (WAN), or the internet. Collectively, the components shown in FIG. 2 provide a hardware and software environment for executing the data aggregation, multi-manager comparison, portfolio modeling, and portfolio optimization processes disclosed throughout this application.

FIG. 2A shows an example of a system for receiving proprietary and third-party data, analyzing and modeling with such data, generating outputs with rankings and user insights, and generating a graphical user interface. FIG. 2A illustrates an embodiment of a system architecture 200A for enabling the delivery of portfolio scoring, optimization, and insight services to user devices through a centralized server infrastructure. The architecture comprises three primary subsystems: a data aggregation module including data providing entities 101C and template store 222, a server 110, and a set of user devices 102, 103, 104, 105 configured to receive interactive outputs and processed insights. This system enables dynamic portfolio generation, multi-manager comparison, and visualization of scoring outcomes based on real-time data, templates, and user-defined rules.

The server 110 functions as the core computational and integration engine. It communicates with external data providing entities 101C, which may include financial data aggregators, market index providers, economic databases, and proprietary information sources. The server retrieves, processes, and stores raw and structured financial data 224 used to power downstream calculations and analytics. In addition, the server accesses a template store 222, which maintains pre-configured and user-defined templates that provide structured formats for scoring models, performance comparison charts, and compliance-related configurations.

Internally, the server 110 includes multiple functional components. The data module 224 handles ingestion, normalization, and organization of incoming data feeds. A rankings and insights module 225 performs comparative analysis of multi-manager portfolios and generates performance scores or rankings based on various criteria such as risk exposure, cost efficiency, benchmark correlation, and other defined metrics. The templates module 226 enables the dynamic loading and application of templates to structure scoring presentations and graphical user outputs. An algorithms and rules module 227 hosts the proprietary logic, rules engines, and optimization models used to evaluate and recommend investment portfolios that align with one or more IC objectives.

The system includes a graphical user interface (GUI) 228 for interaction with client-facing applications. The GUI 228 may be delivered through either a native application 221 or a web browser 223 executing on user devices 102-105. These user devices may include desktop terminals, laptops, tablets, or smartphones operated by investment analysts, portfolio managers, or compliance officers. On the user side, the system also captures and presents user insights 220, which may reflect preferences, tolerances, or observational feedback gathered through interactive dashboards or analytic modules. Applications running on the user devices 221 may enable customized scoring adjustments, priority input for specific investment objectives, and real-time exploration of portfolio configurations.

Together, the architecture 200A supports a closed-loop system for receiving raw financial and structural data, applying templates and algorithms, generating comparative insights, and presenting customized outputs to users in an interactive and responsive format. This structure facilitates the delivery of tailored investment strategies and optimized portfolios in accordance with distinct IC mandates and complementary portfolio objectives.

The servers 110 are also configured to store rankings and insights 225 generated as outputs in 102, 103, 104, 105, and 106, which the servers use in generating graphical user interface 228 pages for presenting information 202 related to the rankings and generated insights 225. The servers 110 generate a graphical user interface 228 that includes the graphical user interface pages. The graphical user interface 228 can be generated based on the computers' programming of data with the inputs of instructions, criteria, parameters, and user insights to produce rankings and insights 225 in 102, 103, 104, 105, and 106. The servers 110 can organize the graphical user interface pages and provide them to user devices 102, 103, 104, 105, and 106.

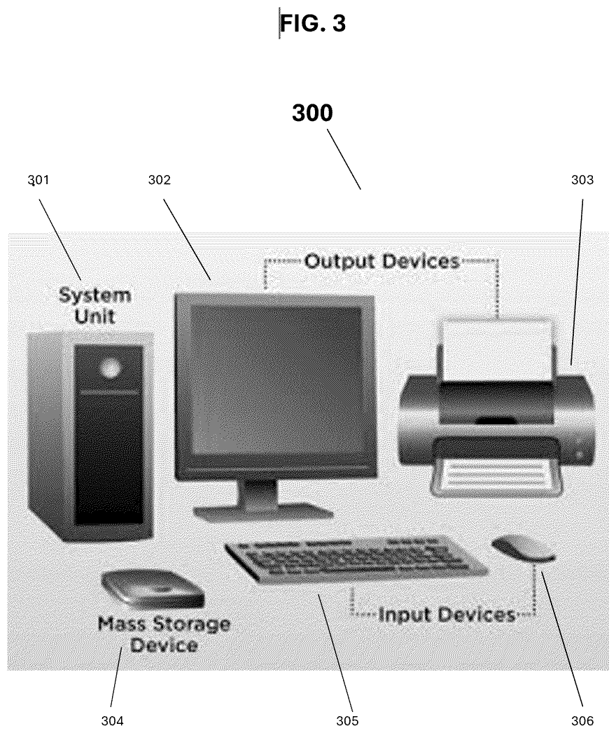

The servers 110 are configured with hardware and software that enable the servers to store 111 and manage data 224 and provide the graphical user interfaces 228. Servers 110 may be any kind of computing device or computing system, such as computing system 200 as shown in FIG. 2. For example, servers 110 may be a desktop computer, a personal computer, a workstation shown in FIG. 3 300, and/or any variation thereof. In another example servers 110 may form part of a distributed computing system. In other examples, the servers 110 may be any kind of electronic device that is configured to store and manage data 224 and generate a graphical user interface 228 in accordance with a part or all the methods disclosed herein. The servers 110 are configured for input from 102, 103, 104, 105, and 106 that include user instructions, criteria, parameters and insights 220 based on data 224, and thereby a source of the computer's algorithms and rules 227 that calculate rankings 225 along with user insights 225.

The servers 110 may receive templates 226 from a template store 222, which may be a server, a data store, a network or other entity that stores templates and related information. In some examples, template store 222 is a service provider. As discussed above, templates 226 are used by the graphical user interface 225 in generating graphical user interface pages 202 that present information related to rankings and insights 225 to users. Each template 226 may include a text field for inserting text that describes rankings and user insights 225, a visual representation field for inserting a visual representation of the rankings and user insights 225, and a link field for inserting a link for accessing information related to the rankings and insights. The graphical user interface 228 pages may be generated by selecting a template 226 and populating the template 226 by filling in the text field, visual representation field, and link field. In some examples, the template store 222 can provide templates including any number of fields and field types.

The server 110 is configured to provide the graphical user interface 228 to the user. For example, the server 110 can transmit program code (e.g., HTML, CSS, or JS) defining the graphical user interface 228 to the user devices 102, 103, 104, 105, and 106, where the program code is executable or interpretable by the user devices 102, 103, 104, 105, and 106 to generate the graphical user interface 228 for display 202 to these users in any suitable manner, such as through one or more application and we browsers. One or more interfaces, such as websites, portals and/or software applications may present rankings and insights 225 to the users. A user of user devices 102. 103, 104, 105, and 106 may access one or more of those interfaces using an application 221 and/or web browser 223 of these user devices 102, 103, 104, 105, and 106 to view the graphical user interface 228 and other interfaces.

The user devices 102, 103, 104, 105, and 106 are configured with hardware and software that enable these user devices to provide an application 221 and web browser 223, and these user devices 102, 103, 104, 105, and 106, for example, may be any kind of mobile electronic device, portable electronic device, workstation 300, desktop, or laptop, as well as other kind of computing device or computing system, such as 200, configured to provide applications 221 and web browsers 223, whether installed on the devices 102, 103, 104, 105, and 106 or cloud based, or in one or more communication channels.

The graphical user interface 228 includes graphical user interface pages for presenting information 101C, data 204, and rankings 205 to the users 102, 103, 104, 105, and 106, as well as insights of the users 220 which have been entered by the users. The graphical user interface 228 can generate a variety of different pages for display on user devices 102, 103, 104, 105, and 106 that present information 101C, data 204, rankings and user insights 205 to the users.

The computing system 200 shown in FIG. 2 includes one or more processors 201, one or more memories 203, RAM 206, one or more storage devices 111, network communication interface 208, and one or more displays 202. The one or more processors 201 can read one or more programs from the one or more memories 203 and execute them using RAM 206. Non-limiting examples of the one or more processors 201 include a Field-Programmable Gate Array (FGPA), an application-specific integrated circuit (ASIC), a microprocessor, or any combination of these. The one or more processors 201 can execute the one or more programs stored in the one or more memories 203 to perform operations. Examples of such operations can include any of the operations described above with respect to the one or more servers 110 and/or the one or more user devices, with an example illustrated in FIG. 3 diagram 300, where such user devices are components of the users' SDAC 102, PDAC 103, PCC 104, PMC 105, CDBO 106. In some examples, the one or more programs can include processor-specific instructions 210 generated by a compiler or an interpreter from code written in any suitable computer-programming language, such as C, C++, C#, Python, or Java.

The one or more memories 203 can be non-volatile and may include any type of memory device that retains stored information when powered off. Non-limiting examples of the memory 203 include electrically erasable and programmable read-only memory (EEPROM), flash memory, or any other type of non-volatile memory. At least some of the memory devices can include a non-transitory computer-readable storage medium 111 from which the one or more processors 201 can read instructions. A computer-readable storage medium 111 can include electronic, optical, magnetic or other storage devices capable of providing the one or more processors 201 with computer-readable instructions or other program code. Non-limiting examples of a computer-readable storage medium include magnetic disks, memory chips, ROM, random-access memory (RAM), and ASIC, a configured processor, optical storage, or any other medium from which a computer processor an read the instructions.

The one or more programs may be configured to display ranked optimizations of portfolios and portfolio management that may become insights 220 to one or more users. In some embodiments, the one or more programs are configured to present ranked optimization data 225 to visually enhance possible insights 220 on the displays 202, shown in exemplary embodiments as components of the users' PCC 104, PMC 105 and CDBO 106, based on the operators' utilization algorithms 227. In some embodiments, the one or more programs are configured to store 111 and manage securities and portfolio management data for one or more users, generating graphical user interface 228 pages for presenting information 202 related to the rankings and insights 225 to the one or more users 102, 103, 104, 105, and 106, and rules 227 for determining how the information related to the rankings and insights 225 should be placed on the graphical user interface 228 pages. The one or more programs may also be configured to generate a graphical user interface 228 and pages 202 therein based on optimization rankings, insights 225, and algorithms 227, as well as organize the graphical user interface 228 pages.

One or more storage devices 111 may be configured to store securities, portfolio management data 224, rankings and insight 225 data. The one or more storage devices 111 may be further configured to store graphical user interface 228 pages. Additionally, the network communication interface 208 may output the securities, portfolio management data 224, algorithm 227, rankings and insights 225 to one or more networks 299. Display 202 may be configured to display images, screens, and interfaces. In some embodiments, display 202 is configured to display graphical user interface 228 pages that present securities data and portfolio management data 224, and rankings and insights 225, in accordance with features described above. In some embodiments, using display 202 and a ranking mechanism 227, one or more users 102, 103, 104, 105, and 106 provide feedback on the insights 220. Such feedback may be used to improve the ranking and insight 225 presentation 202.

The systems, methods, and apparatus of the present disclosure may be implemented using hardware, software, firmware or a combination thereof and may be implemented in one or more computer systems or other processing systems. Some embodiments of the present disclosure include a system including one or more processors 201. In some embodiments, the system includes a non-transitory computer readable storage medium containing instructions, which, when executed on the one or more processors 201, cause the one or more processors 201 to perform part or all of one or more methods and/or part or all of one or more processes disclosed herein. Some embodiments of the present disclosure include a computer-program product tangibly embodied in a non-transitory machine-readable storage medium, including instructions 210 configured to cause one or more processors 201 to perform part or all of one or more methods and/or part or all of one or more processes disclosed herein.

In the investment management industry, it is unconventional and not customary to select portfolio managers using the security and portfolio level analyses of portfolio behavior in various circumstances and stress scenarios. It also is unconventional and not customary to have separate ICs join to invest in a single portfolio to optimize their different, distinct and complementary objectives. In one embodiment of the invention, FIG. 1 diagrams a computer-implemented system and method of how two ICs, 101A and 101B, with complementary objectives, work toward a cooperative way to have a single portfolio 114 that serves their complementary objectives. The ICs may work separately or cooperatively in this process. In this embodiment IC 101A has the objective of higher-than-average dividend income that continually increases and is labelled the Money Escalator IC. IC 101B has the objective of higher-than-average capital gains and is labelled the Loan-less Leverage IC.

The specialized computers comprising this embodiment include a securities data aggregation computer (SDAC) 102, a portfolio data aggregation computer (PDAC) 103, a portfolio multi-manager comparison computer (PCC) 104, a portfolio modeling computer (PMC) 105, a computer displaying comparisons of multi-manager portfolios' characteristic benefits and obligations (CDBO) 106. All five specialized computers 102, 103, 104, 105, and 106, have graphical tools for displaying 228 202 of data and outcomes. Note that the number of individual computers in other embodiments may be as few as one, or more than five, while performing the functions described for each computer in this embodiment. In this embodiment, all processors and servers 110 are a single computer system in one location, though they may be in separate locations in other embodiments. Note that in this embodiment each specialized computer 102, 103, 104, 105, and 106, transmits its data to the servers 110 that all five computers employ, and all data is stored in the same server data storage 111. While the data from each specialized computer 102, 103, 104, 105, and 106 is transferred to the other computers 102, 103, 104, 105, and 106, in this embodiment the transfers go through the servers employed by all the computers. In other embodiments the specialized computers 102, 103, 104, 105, and 106 may transfer between them directly.

FIG. 3 shows an example of a user workstation that may be used for each of the specialized computer functions, which may be one or more computer workstations for all specialized computer functions, in one or more locations. The computer system 300 that may be employed for implementing, interacting with, or managing the portfolio optimization systems and user interfaces described in previous figures. The system 300 includes conventional computing hardware components used in both server-side and client-side environments to access, manipulate, and output portfolio data, analytics, and graphical user interface content.

The system includes a computer tower 301, which houses the central processing unit (CPU), memory, storage devices, and necessary interface hardware for performing computational tasks. The computer tower 301 is operably coupled to a display monitor 302, which visually presents information to the user, such as interactive dashboards, scoring templates, optimization results, and portfolio comparison charts. The monitor 302 includes a display screen 305 capable of rendering graphic content via a graphical user interface (GUI), such as that shown in FIG. 2A (reference 228), enabling user interaction with financial data and investment recommendations.

Also connected to the computer tower 301 is a printer 303, which may be configured to receive output instructions and generate hard-copy printouts of data reports, portfolio summaries, scoring results, compliance checklists, or other documentation. The printer 303 communicates with the computer 301 via a communication line or wireless interface 306. This output capability supports audit trail generation, physical distribution of portfolio outputs, and offline review of system-generated materials by fund administrators or compliance personnel. Collectively, the components illustrated in FIG. 3 represent a hardware platform configured to execute software applications (e.g., scoring engines, comparison dashboards) and to facilitate user interaction with system-generated data, insights, and legal documentation relevant to multi-IC portfolio optimization systems. This system may be implemented in a standalone workstation, networked terminal, or part of a distributed enterprise deployment across financial institutions.

As noted above, the users' 102, 103, 104, 105, and 106 computing system 200 may also include other input 204/output 208 devices, examples of which are shown in FIG. 3 diagram 300. Examples of such input components can include a mouse 306, a keyboard 305, a trackball, a touch pad, and a touch-screen display. Examples of such output components can include the display 202 and 302, an audio display, and a haptic display. Examples of a display 202 and 302 can include a liquid crystal display (LCD), a light-emitting diode (LED) display, and a touch-screen display. An example of an audio display can include speakers. Examples of a haptic display may include a piezoelectrical vibration device or an eccentric rotating mass (ERM) device.

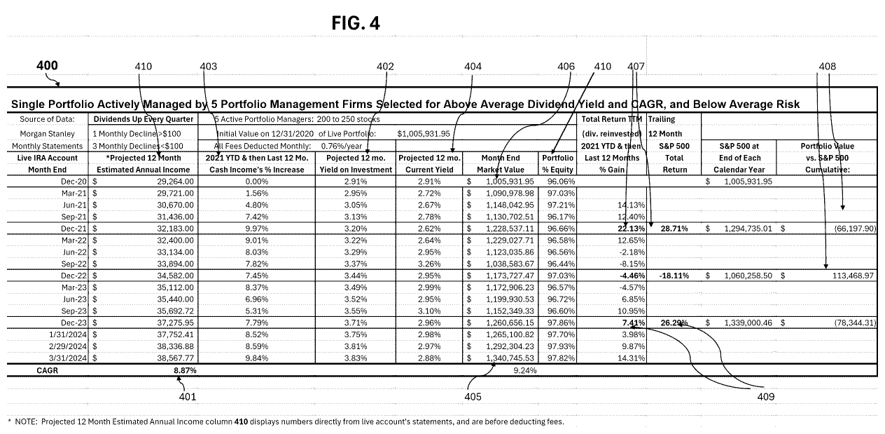

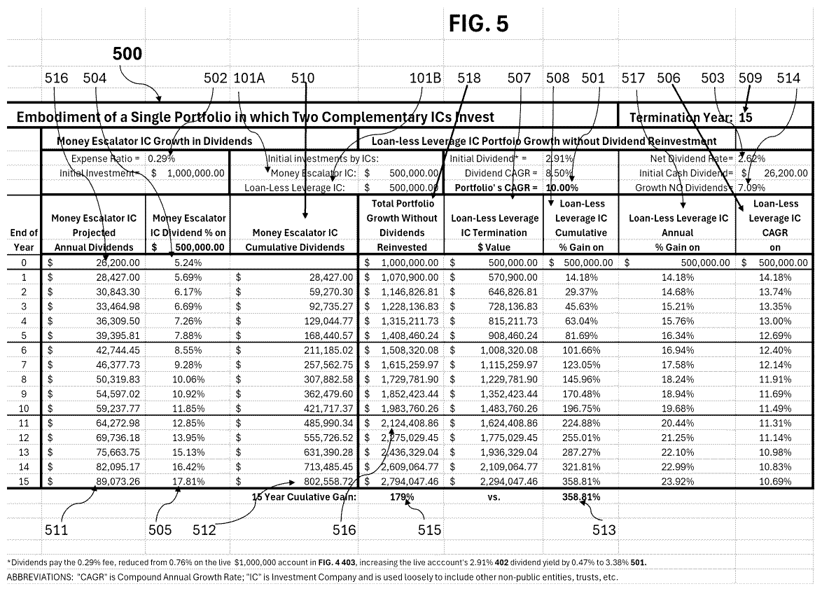

FIG. 4 is provided to document the enablement of results from the invention's use by showing a performance data table of actual returns of a live and actively managed portfolio; the table provides historical returns of one account managed by five portfolio management firms; the performance data provides a realistic basis for the assumptions used in the invention's performance scenarios that follow in FIGS. 5 through 13, in accordance with some embodiments. FIG. 4 illustrates a performance data table 400 documenting actual historical returns from a live investment portfolio actively managed by five separate portfolio management firms. The five portfolio managers were selected by an institutional investment consultant using continually updated manager data provided by a large portfolio management research department of a major U.S. investment firm. This portfolio comprises between 200 and 250 stocks and is managed with the objective of achieving above-average dividend yield, strong compound annual growth rate (CAGR), and below-average risk. The table presents month-end performance data collected across a 39-month period beginning at the end of December 2020 and continuing through March 2024. The table serves as evidence of enablement by providing a realistic and empirical foundation for the return assumptions applied in the hypothetical modeling scenarios, which are examples of the CDBO 106 graphical user interface displays 202, as illustrated in FIGS. 5 through 13.

FIG. 4 is an example of the Portfolio Modeling Computer (PMC) 105 output as may be seen on a graphical user interface display 202, providing examples of the types of data that may be used by the management of the potential IC investors in selecting a single portfolio manager, or optimized portfolio manager combinations. FIG. 4 allows the ICs to test various assumptions, including but not limited to proportionate investments by each IC, expense ratios, dividend growth rates, termination years (if any are selected), and inclusion of specific portfolio managers. FIG. 4 shows the data from a live portfolio in which five portfolio managers each select securities for 20% of the total portfolio. Note that the data of current portfolios' performance may then be used to provide the assumptions in the CDBO 106 output, as illustrated in examples of the GUI displays 202 in FIGS. 5 through 13.

As shown in column 410, the portfolio delivered a projected 12-month estimated annual income that grew from $29,264.00 in December 2020 to $38,356.86 in March 2024, reflecting a compound annual growth rate (CAGR) of 8.87% 401 in projected income. The data confirms consistent increases in cash income over time, with 12-month increases noted in column 403. Column 402 specifies the projected 12-month yield on investment, which increased from 2.91% to 3.83% between Dec. 31, 2022 and Mar. 31, 2024, demonstrating a continually increasing income return profile even as market conditions fluctuated, including the 18.11% decline of the S&P 500 in 2022 (column 407). Note that in 2022 the portfolio declined 4.46%, demonstrating the significantly lower volatility and risk of the portfolio compared to the S&P 500 (column 407).

Column 404 reports the portfolio's month-end current yield, defined as the projected 12-month income divided by current market value, providing an up-to-date indicator of dividend expectations on a rolling basis. Column 406 shows the month-end market value of the live account, beginning at $1,005,931.95 and increasing to $1,340,745.89 405 by March 2024. The data indicates a net upward trend in market value, with short-term drawdowns reflected in specific periods, such as between March and December 2022.

Column 410 provides the portfolio's equity allocation as a percentage of total assets, with values typically ranging between 96% and 98%. This stability suggests a consistent equity-focused investment policy that achieves the objectives of above average cash flow and capital appreciation. Column 407 reports the portfolio's trailing 12-month total return, including reinvested dividends. Returns ranged from −4.46% to 22.13% annually, showing the impact of market cycles and macroeconomic events on short-term performance. In parallel, the table provides benchmark performance for the S&P 500 index during the same periods.

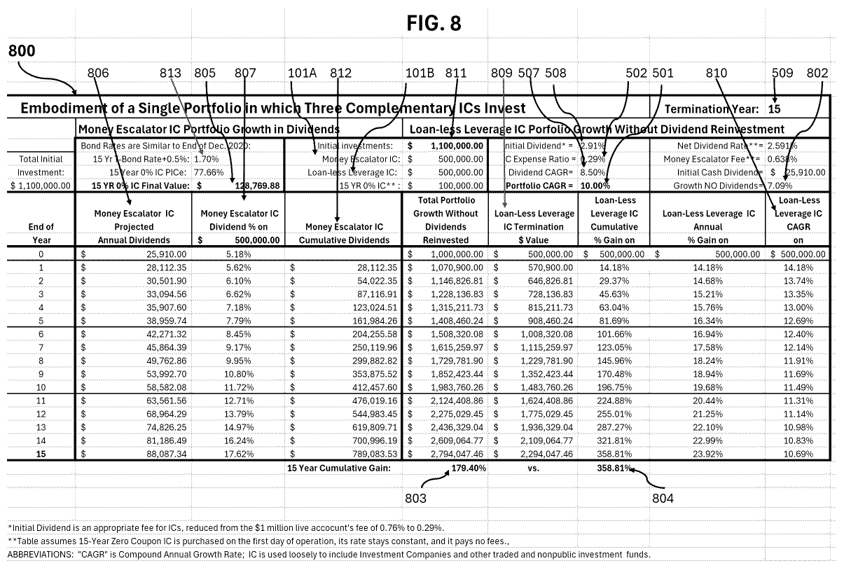

To contextualize relative performance, column 408 compares the cumulative difference between the portfolio's market value and the corresponding S&P 500 benchmark value at each year-end. This cumulative comparison shows both underperformance (e.g., −$66,197.90 in December 2021) and outperformance (e.g., +$113,468.97 in December 2023) across various time frames of the portfolio compared with the S&P 500, depending on market behavior. Column 407 provides annual total returns for the S&P 500 for direct comparison against the live portfolio. Together, the data presented in FIG. 4 illustrates the ability of a multi-manager portfolio to generate competitive income and capital appreciation over time, while operating within a risk-managed, equity-heavy allocation. The performance metrics, particularly the consistent dividend income growth and relatively stable yield levels, form a credible and enabling basis for the modeling assumptions (e.g., 7%, 10%, and 13% annual return cases) that underlie the hypothetical scenarios set forth in subsequent FIGS. 5 through 13. Note that in FIGS. 8 through 11, the interest rate assumptions use the rates on U.S. Treasury bonds on Dec. 31, 2020, when the FIG. 4 live portfolio began. Those scenarios assume the interest-bearing ICs 805 and 1105 provide an interest rate of 1.7% that is 0.5% greater than the 15-year U.S. Treasury bond annual interest rate of 1.2%. FIGS. 5 through 13 provide clear evidence of the invention's enablement of significantly more returns with significantly less risk than available with investments of similar returns.

FIGS. 5 through 13 provide scenarios for three embodiments of the invention. Note that in FIGS. 5 through 13 it is assumed that the same single portfolio of investments is used in all nine scenarios. It is a result of the complementary objectives of each IC that the same single portfolio, carefully selected, meets their objectives in a manner that provides significantly more, with less risk, than available from a conventional, customary portfolio. The portfolio assumptions from FIG. 4 are used in FIGS. 5 through 13 because all of those scenarios assume they are invested in the portfolio that provides the data for FIG. 4.

FIGS. 5 through 13 are examples of output of the CDBO 106 in the computer driven invention, with the GUI 202 of scenarios illustrating the enablement of the invention's output achieving the complementary objectives of separate investment companies investing in a single portfolio.

FIG. 5 shows a hypothetical performance scenario for TWO ICs with complementary objectives, assuming a 10% annual total return, which is the U.S. equity markets long-term average growth rate. FIG. 5 illustrates an embodiment 500 of a performance scenario demonstrating how a single optimized portfolio may simultaneously serve the complementary objectives of two investment companies (ICs): a Money Escalator IC 101A and a Loan-less Leverage IC 101B. This scenario assumes an initial investment of $1,000,000, evenly split between the two ICs, and models portfolio performance under a hypothetical 10% compound annual growth rate (CAGR), as indicated in 501. The modeled scenario includes a termination period at the end of year 15, shown in 509, with financial outcomes calculated showing a continual increase of dividends in column 510 and an increase of principal for the entire portfolio without dividend reinvestment in column 518.

As shown in columns 504 and 516, the Money Escalator IC 101A can achieve its objective of growing dividend income, with a projected annual dividend in column 516 starting at $26,200 and increasing steadily to $89,073.26 by the end of year 15 511. The corresponding dividend yield, as a percentage of the original $500,000 capital contribution, shown in column 504, increases from 5.24% to 17.81% 505 over the same 15 year period. These escalating dividend payouts achieve the objectives of increasing cash distributions for income-focused investors, including but not limited to pension funds for corporate and governmental entities; endowments for universities, hospitals, libraries, museums, NGOs, and nonprofit organizations; charitable foundations; insurance companies; and for those nearing or in retirement.

The total cumulative dividends received by the Money Escalator IC are listed in column 510 and grow to $802,558.72 512 by the end of the 15-year period. Notably, this return profile is achieved without reinvestment of dividends, thereby allowing for increasing liquid income while preserving the original capital commitment.

Simultaneously, the Loan-less Leverage IC 101B, as detailed in columns 506, 507, 508, and 517, has its objective focused on capital appreciation without dividend reinvestment. Starting from an equal $500,000 initial investment, the reinvested portfolio value compounds annually, reaching $2,294,047.46 at the end of year 15 (column 507). Column 508 reflects the cumulative percentage gain for the Loan-less Leverage IC, amounting to 358.81% 513.

The compound annual growth rate (CAGR) values for the Loan-less Leverage IC's capital appreciation are displayed in column 506, starting at 14.18% and descending to 10.69% in the final year. Column 508 highlights the year-by-year annual gain percentages for the Loan-less Leverage IC.

The value of this column 506 in the CDBO 106 computer output display 202 is that we can see that as the portfolio grows the leverage decreases. In this embodiment, the $500,000 initial investment by the Money Escalator IC 101A is also its value at termination in 15 years. This means that at the start the leverage is 50%, but at the end of 15 years the leverage is only 17.9% ($500,000/$2,794,047.46). Simultaneously, the Money Escalator IC 101A gets the benefit of the increase in the portfolio size, so its dividends grow at an accelerating rate as seen in column 504. The dashboard display illustrated as FIGS. 5 through 13 allows the ICs to decide what combination of initial investments and the number of years to termination (if any) optimize the objectives of each IC. And rather than a choice of only 1 termination year, the ICs may choose to invest in a portfolio to end in 5 years, another to end in 10 years, and a third to end in 15 years. These dashboards illustrated in FIGS. 5 through 13 clarify the choices for ICs.

Finally, the table captures the 15-year cumulative gain as 179.4% 515 in column 518 for the single portfolio that provides benefits to both ICs, the Money Escalator IC 101A and the Loan-less Leverage IC 101B. Note the large difference in returns for the single portfolio gain (undivided) of 179.4% vs. 358.81% for the Loan-less Leverage IC as shown in 515 and 513. These outputs demonstrate how the invention's system achieves different and complementary investor mandates—such as income generation for one IC 101A simultaneously with capital growth for another IC 101B, investing in a single multi-manager portfolio's shared assets and algorithmically driven allocations of benefits, risks, and obligations. This scenario serves as one example of how the CDBO 106 GUI 202 displays do enable the multi-IC optimization logic of the invention, and clearly presents to investors the transformation to substantially more performance with less risk than customarily and conventionally available.

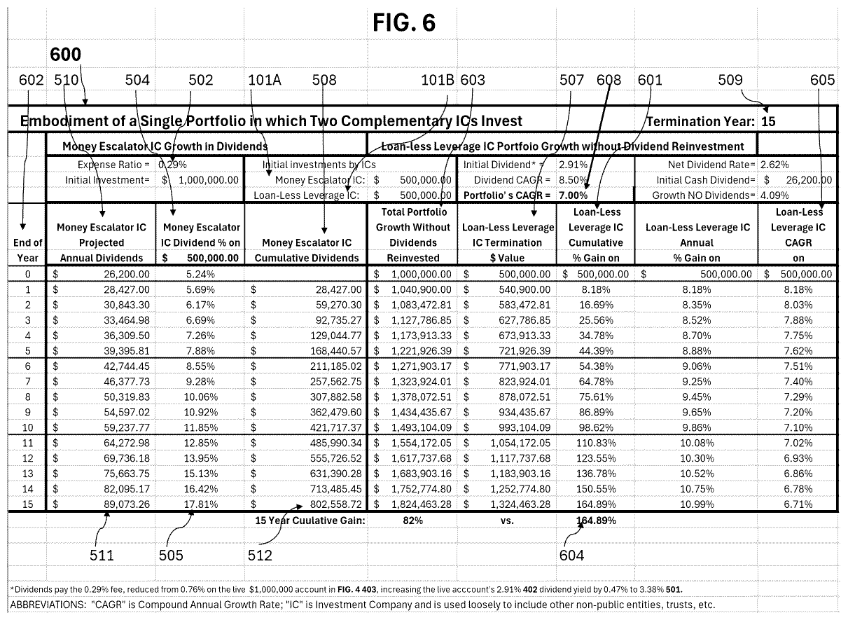

FIG. 6 shows a hypothetical performance scenario for TWO ICs 101A and 101B with complementary objectives, assuming a 7% annual total return 608. FIG. 6 illustrates an embodiment 600 of a performance scenario in which a single portfolio supports the investment mandates of two complementary investment companies (ICs): a Money Escalator IC 101A and a Loan-less Leverage IC 101B. This embodiment models portfolio performance under a more conservative U.S. equity markets assumption of a 7% compound annual growth rate (CAGR), as indicated in 606. The scenario assumes an equal $500,000 investment from each IC into a unified portfolio totaling $1,000,000, with the investment commencing at the end of year 0 and continuing through a 15-year termination period 509, also indicated in column 602.

The Money Escalator IC 101A has the objective of steadily growing annual income through dividends, and receives all dividends from the single portfolio and pays all fees. Column 510 reflects projected annual dividends, beginning at $26,200 and rising to $89,073.26 by the end of year 15. Column 504 shows the dividend yield as a percentage of the initial investment, increasing from 5.24% to 17.81%, demonstrating a compounding increasing income stream. Column 508 tracks cumulative dividends received over the 15-year life of the investment, reaching $802,558.72 by the end of the term. The strategy, which excludes reinvestment of The Money Escalator IC 101A receives all dividends, i.e., no dividends are reinvested, and achieves predictable, increasing cash flows and income security.

Simultaneously, the Loan-less Leverage IC 101B receives all of the portfolio growth without dividend reinvestment, and pays no fees. The initial investment of $500,000 yields a dividend-reinvestment-free capital growth trajectory, ultimately reaching a terminal value of $1,324,463.26 in year-end 15, as indicated in column 507. Column 601 displays the cumulative percentage gain of 164.89% 604, and column 605 shows the internal CAGR for this approach tapering to 6.71% by the end of the period. These outcomes reflect FIG. 6's scenario of a poor U.S. equity markets long-term return. FIG. 6 is a CDBO 106 GUI display 202 that allows ICs to understand the invention in practical use during a long period of poor equity markets.

The overall portfolio growth without dividend reinvestment is documented in column 603. Starting from $1,000,000, the portfolio reaches $1,824,463.28 by year-end 15. Column 603 highlights the corresponding cumulative portfolio gain of 82%, which is substantially lower than the 179% shown under the 10% return assumption of FIG. 5, thereby emphasizing the CDBO 106 GUI display 202 ability to show the level of achievement of objectives in periods of differing market returns.

The side-by-side presentation of the Money Escalator IC 101A and Loan-less Leverage IC 101B results underscores the invention's ability to construct a unified portfolio that delivers differentiated benefits-income escalation simultaneously with capital appreciation-using the same portfolio's underlying assets. The system enables each IC to realize its distinct and complementary objectives through tailored participation in a shared portfolio vehicle, with dynamic projections guided by input priorities, algorithmic allocation, and legal structure constraints. This embodiment highlights the utility of the system in more constrained economic climates while demonstrating the ongoing alignment of portfolio performance with the complementary goals of participating ICs.

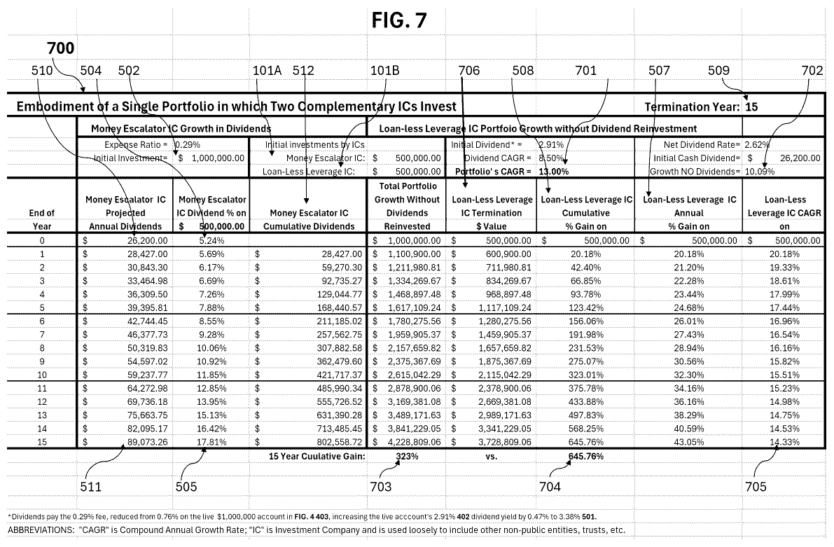

FIG. 7 shows a hypothetical performance scenario for TWO ICs 101A and 101B with complementary objectives, assuming a 13% annual total return. FIG. 7 illustrates an embodiment 700 of a performance scenario in which a single, unified portfolio is structured to support two complementary investment companies (ICs): a Money Escalator IC 101A and a Loan-less Leverage IC 101B. The embodiment, already examined in FIGS. 5 and 6, is modeled in FIG. 7 displaying portfolio behavior under an optimistic market condition, assuming a 13% compound annual growth rate (CAGR), as reflected in 701. The scenario assumes equal capital contributions of $500,000 from each IC for a total portfolio investment of $1,000,000 (502), with performance measured over a 15-year term, indicated in 509.

The Money Escalator IC 101A is focused on maximizing the growth of dividend income, without reinvestment. As shown in column 510, the projected annual dividend begins at $26,200 and increases steadily to $89,073.26 511 by year-end 15. The dividend yield, expressed as a percentage of the original $500,000 contribution, is detailed in column 504 and grows from 5.24% in year 0 to 17.81% 505 in year-end 15. Column 512 reflects the cumulative dividends received over the 15-year term, totaling $802,558.72. This structure supports income-dependent investors seeking a reliable and expanding stream of distributions.

Simultaneously, the Loan-less Leverage IC 101B, by contrast, is designed to maximize capital appreciation by retaining all earnings without reinvestment of dividends. The performance of this 101B IC, and achievement of its objective, is shown in columns 507 through 508. Beginning with the same $500,000 initial investment, the Loan-less Leverage IC 101B reaches a terminal value of $3,728,006.09 by year 15 (column 706). Column 508 presents the corresponding cumulative gain of 645.76% 704, and the taper over time of the compound annual growth rate (CAGR), ranging from 20.18% in year 1 to 14.33 in year-end 15, is shown in 705.

The total portfolio value without reinvested dividends is presented in column 703, increasing from $1,000,000 to $4,228,006.09 by year 15. This results in an aggregate 15-year cumulative gain of 323%, as indicated in column 703. This scenario highlights the potential magnitude of returns available when both dividend growth and capital appreciation objectives are simultaneously served by a computer-driven systemically allocated multi-manager portfolio.

The differences in outcomes between the two ICs 101A and 101B reinforce the system's ability to deliver divergent benefits using a shared underlying investment strategy. While the Money Escalator IC 101A receives substantial and increasing annual distributions without compromising capital, the Loan-less Leverage IC 101B realizes significant compound growth through retained earnings and value accumulation impacting the portfolio's stock prices. These results are enabled by the system's algorithmic allocation and scoring mechanisms, which balance competing IC objectives through a unified, rules-based portfolio construction methodology. This embodiment demonstrates the utility and flexibility of the invention in high-growth environments, further validating its scalability across varying market conditions.

FIGS. 5, 6, and 7 illustrate performance scenarios in which each of two complementary investment companies (ICs)—namely, IC 101A and IC 101B—invested equally, contributing 50% of the total capital into a single shared investment portfolio. These examples demonstrate proportionate investment structures that serve as model use cases for the computer-driven portfolio construction system described in FIG. 1. The CDBO 106 output data display 202, illustrated in FIGS. 5, 6, and 7, of these scenarios provides a foundation for ranking the utilization of best proportions of investment from each participating investor IC, here to collectively optimize the complementary objectives of IC 101A and IC 101B. These performance results are generated and displayed by the Computer Displaying Benefits and Obligations (CDBO) module 106, which dynamically renders outcomes on its graphical display interface 202.

As described with FIGS. 5, 6, and 7, the CDBO 106 output GUI display 202 allows clear views of the achievement of objectives by the ICs in various market conditions. The ICs have the scenarios' data to find the leverage appropriate to the capital appreciation objective of the Loan-less Leverage IC 101B, and can view the declining leverage of 101B (as the portfolio value increases) alongside of the continually increasing dividend income stream of the Money Escalator IC 101A.

The graphical output 202 of the PMC 105 (FIG. 4) and CDBO 106 (FIGS. 5 through 13) show the performance of both single portfolios and combinations of portfolios under various investment conditions and configurations. In particular, the one embodiment's performance displayed in FIGS. 5 through 7 market scenarios highlight how the specific characteristics and weighting of the portfolio components may produce optimized results that align with each IC's distinct goals. For each participating IC, the system provides data detailing the potential benefits and obligations of candidate model portfolios. These portfolios are ranked and evaluated using algorithmically determined performance metrics based on alternative weightings of selected characteristics. The CDBO 106 then dynamically generates and displays those rankings and comparisons on graphical interface 202, exemplified in FIGS. 5 to 13.

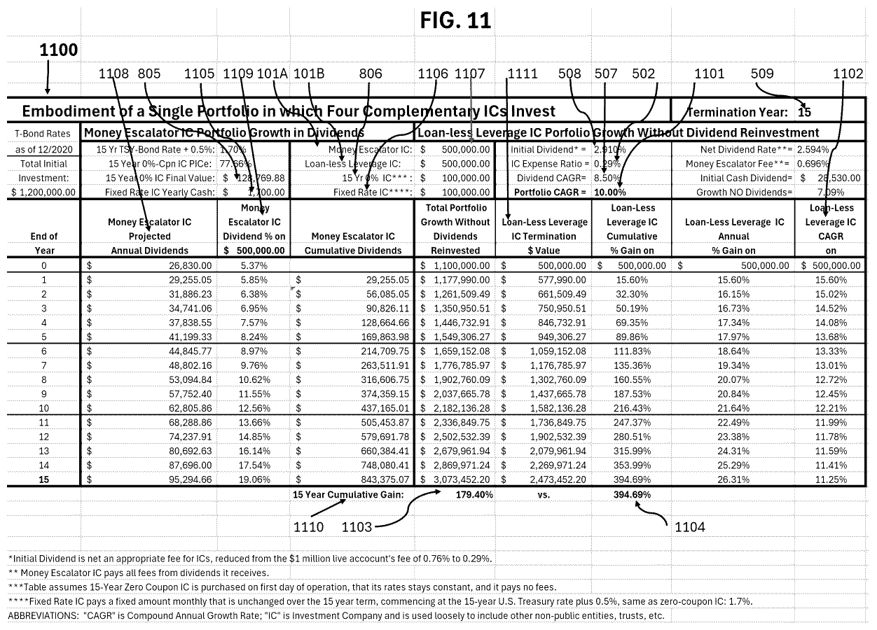

The CDBO 106 processor is further configured to accept input regarding each IC's alternative percentage investments in the single shared portfolio 114. Using this input, the CDBO 106 calculates and ranks candidate portfolio managers and their respective portfolio combinations, presenting the results in a user-interactive format on graphical tool 202. This dynamic visualization tool allows stakeholders to explore various portfolio outcomes under alternative initial investment allocations, including: a) the fixed 50%/50% initial investments in FIGS. 5, 6, and 7; b) the 9.1%/45.45%/45.45% initial investments in FIGS. 8, 9, and 10; and the 8.33%/8.33%/41.66%/41.66% in FIGS. 11, 12, and 13. Additionally, the processor may receive a termination date input from IC 101A, as well as 805 and 1105, and in such cases, the CDBO 106 calculates and displays the projected market value of IC 101B's holdings at the termination point if IC 101B continues investing post-termination. FIGS. 5 through 13 incorporate such termination considerations into their respective scenario outputs.

Moreover, the CDBO 106 is capable of calculating results across a range of alternative investment percentages for each IC and displaying outcomes for both single and combined portfolio configurations based on defined investment characteristics and constraints. The graphical representation 202 reflects these calculations in a clear and comparative format. In doing so, the CDBO 106 identifies and displays the optimal investment amounts for each IC in the single portfolio 114 that best meet their complementary objectives. These capabilities are exemplified in FIGS. 5 through 13, which consistently model three examples of ways for ICs to create investment splits and illustrate the system's ability to deliver optimized outcomes for each investor profile.

The final output 113 of the CDBO is the generation of a Single Investment Portfolio (SIP) 114, optimized for the complementary investment goals in the embodiment of IC 101A and IC 101B (FIGS. 5 to 7); in the embodiment of 101A, 101B, and 805 (FIGS. 8 to 10; and in the embodiment of 101A, 101B, 805, and 1105 (FIGS. 11 to 13). This output enables the participating ICs to proceed with funding the SIP 114 according to the optimized configuration, including predefined benefits and obligations for each party. The CDBO 106 operates in conjunction with a distributed architecture of function processors, including SDAC 102, PDAC 103, PCC 104, PMC 105, and CDBO 106 itself, along with associated servers 110. These processors may be implemented on a single physical computing unit or across multiple distributed processors in separate geographic locations. In multi-location embodiments, each processor 102-106 communicates with the graphical interface 202 over a network to maintain real-time synchronization whenever real-time synchronization may be required.

Further details of the system, method, and apparatus are illustrated in FIG. 1 and its corresponding Chart 100. Third-party data 101C is provided to the Securities Data Aggregation Computer (SDAC) 102 by vendors such as FactSet, Bloomberg, Moody's, Standard & Poor's, and exchanges. The Portfolio Data Aggregation Computer (PDAC) 103 receives third-party data 101C from brokerage firms, portfolio management firms, Morningstar, and research organizations. Additionally, the CDBO 106 accesses third-party legal structure data 101C to evaluate potential cooperative structures between ICs participating in a shared investment portfolio. All such data is retained in memory and server storage associated with SDAC 102, PDAC 103, and servers 110 and 111.

The Portfolio Comparison Computer (PCC) 104 retrieves input data from SDAC 102 and PDAC 103, synthesizing and analyzing it using proprietary algorithms 227. These algorithms incorporate factors such as security characteristics, historical market data, analysts' ratings, and past portfolio performance under varied conditions. Subsequently, the Portfolio Modeling Computer (PMC) 105 applies additional proprietary algorithms 227 to simulate and compute portfolio combinations and associated management strategies, considering similar evaluative criteria. The outcome of these computations includes portfolio rankings and weightings, which are displayed through the graphical interface 202 as an interactive tool for exploring optimized solutions aligned with each IC's investment strategy and constraints. FIG. 4 is one example of PMC 105 data output as shown in the graphic user interface 202.

FIGS. 8 through 11 show hypothetical performance scenarios for an embodiment having THREE ICs with complementary objectives, with FIG. 8 assuming a 10% annual total return 501. FIG. 8 illustrates an embodiment 800 of a CDBO 106 hypothetical performance scenario involving three complementary investment companies (ICs) that jointly invest in a single portfolio. The portfolio begins with a total investment of $1,000,000 (shown in column 811) initial investment from three ICs: 45.45% from Money Escalator IC 101A, 45.45% from Loan-less Leverage IC 101B, and 9.1% from the third IC labelled 15 Year 0% IC 805. The scenario spans a 15-year investment horizon ending in year 15, as shown in 509.

The Money Escalator IC 101A receives the continually growing annual dividend distributions, without reinvesting them. As shown in column 806 projected annual dividends start at $25,910 and increase steadily each year and increase at the annual rate of 8.5% 507 (used in the 9 FIGS. 5 to 13), reaching 88,087.34 by year-end 15. The dividend yield, shown in column 807, grows from 5.18% to 17.62% over the same period. Column 812 tracks cumulative dividends received, totaling $789,083.53 by the end of the 15 year term. Under average equity market conditions, the Money Escalator IC 101A achieves its objectives of predictable and increasing cash flow while maintaining capital stability, as the initial investment is returned at termination in year-end 15.

Simultaneously, the Loan-less Leverage IC 101B has a capital appreciation objective without dividend reinvestment. Starting from a $500,000 allocation (shown in column 811), the value of this portion grows to $2,294,047.46 by year-end 15, as shown in column 809. Column 804 indicates the cumulative gain for the Loan-less Leverage IC is 358.81%, with corresponding compounding annual percentage gains shown in column 810 gradually tapering to 10.69% in the final year. The capital growth trajectory reflects disciplined compounding over the modeled 10% portfolio CAGR. The declining CAGR reflects the declining leverage for 101B as the portfolio size increases.

Column 803 displays the total portfolio value over time, excluding dividend reinvestment. By year-end 15, the total value reaches $2,794,047.46, representing a cumulative gain of 179%, as shown in column 803. These figures illustrate the capacity of the system to serve income and growth mandates concurrently through algorithmic allocation within a shared portfolio.

Importantly, this embodiment introduces a third IC into the investment structure, with three scenario displays of this embodiment in FIGS. 8, 9, and 10. The 15 Year Zero Coupon IC 805 has an initial investment of $100,000 (shown in column 811), and a Final Value is $128,769.88 (805), and is calculated when the IC is initially offered, and a zero coupon U.S. Treasury bond is purchased at the time of initial offering with the initial investment by this IC of $100,000. The 1.7% interest rate 813 assumed for the six scenarios (FIGS. 8 to 13) with the 15-year Zero Coupon IC is 0.5% above the 1.2% rate on 15-year U.S. Treasury bonds on Dec. 31, 2020, when the live portfolio displayed in FIG. 4 was initiated.

The architecture and projected returns demonstrate the invention's scalability, showing that a single investment structure can accommodate the goals of three distinct ICs. The invention's system dynamically adjusts portfolio allocations to ensure that each IC's objectives, whether based on cash-flow yield, capital appreciation, or zero-coupon yield are fulfilled, even under shared management and performance assumptions. Overall, FIG. 8 illustrates the enablement of a multi-entity investment configuration under realistic growth assumptions, reinforcing the invention's application to real-world investors with varying but complementary goals.

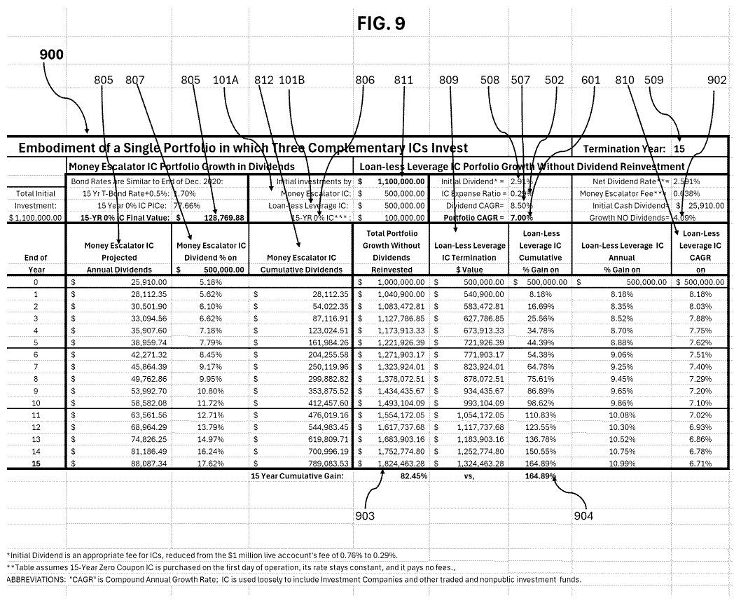

FIG. 9 shows a hypothetical performance scenario for the same THREE ICs with complementary objectives, assuming a poor market with a 7% annual total return, in accordance with some embodiments. FIG. 9 illustrates an embodiment 900 of a performance scenario in which a single portfolio is utilized by the same three complementary investment companies (ICs) in FIG. 8—namely, a Money Escalator IC 101A, a Loan-less Leverage IC 101B, and a 15-Year Zero-Coupon IC 805—to achieve their distinct investment goals over a 15-year period 509. The total initial investment in the portfolio is $1,100,000, with equal contributions of $500,000 from the Money Escalator 101A and Loan-less Leverage 101B ICs and a $100,000 contribution from the Zero-Coupon IC, as shown in column 811 This scenario is modeled under a conservative 7% portfolio compound annual growth rate (CAGR) 601, and reflects a market environment similar to that at the end of 2020, where 15-year Treasury bond rates hovered near 1.2% and the IC-specific rate assumption was set to 1.7%, an increase of 0.5% above the 15 year U.S. Treasury bond rate.

As shown in column 805, the Money Escalator IC 101A receives steadily growing dividend income, increasing at the same rate used in FIGS. 5 to 13: 8.5%/year. Column 805 details the projected annual dividend, starting at $25,910 at the end of year 0 and increasing to $88,087.34 in year-end 15. The corresponding dividend yield as a percentage of the original $500,000 investment rises from 5.18% to 17.62% over the same period, as reflected in column 807. The cumulative dividend income over the 15-year term is summarized in column 812, amounting to $789.083.53. This embodiment's structure is ideal for income-focused investors who prioritize growing distributions over capital appreciation.

The Loan-less Leverage IC 101B has a capital growth objective without dividend reinvestment. Columns 809 show the compounding growth of the IC's $500,000 contribution under a 7% CAGR 601, reaching a termination value of $1,324,463.26 by year-end 15. Column 904 shows the cumulative gain of 164.89%, while the annual percentage returns taper slightly over time, from 8.18% and reaching 6.71% in the final year (column 810). These results demonstrate consistent capital appreciation while excluding reinvested income, thus supporting ICs with growth objectives in periods reflecting poor market assumptions.

Column 903 presents the value of the equity portfolio over time without dividend reinvestment. Starting at $1,000,000, the value rises to $1,824,463.28 by year-end 15, corresponding to a cumulative gain of 82.45 The modeled outcome highlights the system's capacity to simultaneously generate differentiated benefits for each IC while operating within a unified investment structure.

This embodiment further includes the 15-Year Zero-Coupon IC 806, which holds a fixed investment of $100,000 and is assumed to compound at the initial interest rate of 1.7% all 15 years, without withdrawals. The specific output for the 15 Year zero-coupon IC is shown at $128,769.88 in 805 in this figure, and its inclusion emphasizes the flexibility of the invention to support fixed-term, low-risk IC strategies alongside more dynamic dividend and equity growth mandates.

The side-by-side comparison of the three ICs demonstrates the invention's ability to allocate resources of a single portfolio to three separate ICs, while simultaneously adhering to the distinct objectives of each participant. The system leverages algorithmic processing, performance rules, and scoring mechanisms to produce investment structures that enable growing income, capital appreciation, and the zero coupon compounding fixed-rate returns within a shared portfolio framework. This embodiment validates the adaptability and scalability of the system across varying market environments and multi-entity objectives.

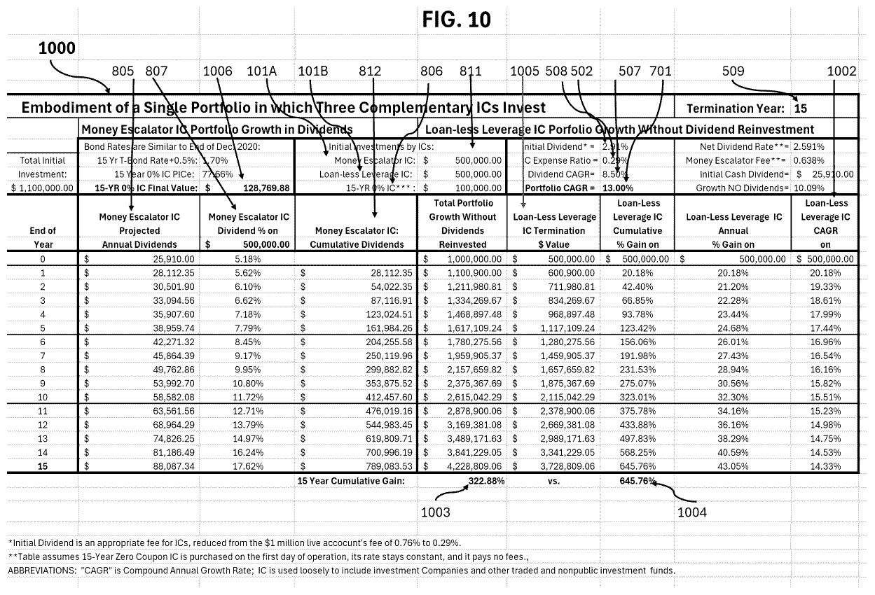

FIG. 10 shows a hypothetical performance scenario for the same THREE ICs with complementary objectives, and in this scenario assuming excellent markets with a 13% annual total return, in accordance with some embodiments. FIG. 10 illustrates an embodiment 1000 of a hypothetical performance scenario in which three complementary investment companies (ICs)—a Money Escalator IC 101A, a Loan-less Leverage IC 101B, and a 15-Year Zero-Coupon IC 806—invest jointly in a single, actively managed portfolio. This embodiment models performance over a 15-year (509) investment horizon under a strong markets' compound annual growth rate (CAGR) assumption of 13%, as shown in 701. The total initial investment is $1,100,000, consisting of $500,000 from each of the Money Escalator 101A and Loan-less Leverage 101B ICs and $100,000 from the Zero-Coupon 15 Year IC 806, as reflected in column 811.

The Money Escalator IC 101A receives projected annual dividend payments without reinvestment. As detailed in column 805, annual dividend payments begin at $25,910.00 and rise to $88,087.34 by year-end 15. The corresponding dividend yield (column 807) increases from 5.18% at the end of year 0 to 17.62% by year-end 15, calculated relative to the initial $500,000 investment. Column 812 shows the cumulative dividend income over the 15-year term, totaling $789,083.53. This structure is intended to serve income-focused investment objectives while preserving the invested principal.

The Loan-less Leverage IC 101B has a capital appreciation objective, with no reinvestment of dividends. Beginning with a $500,000 allocation (column 811), the value of this IC's share of the portfolio increases to $3,728,809.06 by year-end 15, reflecting a cumulative gain of 645.76% (columns 1004 and 1005). Column 1002 shows the year-by-year percentage return on investment, tapering from 20.18% in year 1 to 14.33% in the final year, reflecting the compound effects of sustained capital appreciation over time and the declining leverage of 101B.

Column 1003 presents the total value of the shared portfolio, excluding reinvested dividends. The portfolio grows from $1,000,000 to $4,228,809.06 over the 15-year term, corresponding to a cumulative gain of 322.88%. This portfolio-level outcome reflects the successful alignment of growth and income objectives through joint investment by three distinct ICs.

The inclusion of the 15-Year Zero-Coupon IC 806—represented in 1006 with a projected final value of $128,769.88—demonstrates how fixed-income instruments may be incorporated alongside growth- and dividend-focused strategies within a unified portfolio. The scenario assumes the zero-coupon investment is made at inception and held to maturity, offering a known terminal value and no interim cash flows, thus serving as a source of compounding of the initial interest rate, and a complement to the more dynamic strategies employed by the other two ICs.

Collectively, this embodiment validates the invention's ability to construct and manage a multi-strategy, multi-manager portfolio that concurrently satisfies income growth, capital appreciation, and compounding fixed-return mandates. The system uses algorithmic scoring and rule-based optimization to harmonize these objectives across a shared investment vehicle, supporting differentiated IC participation in benefits, risks, and obligations, with performance results that provide significantly more than conventional and customary independent investment structures. FIG. 10 exemplifies the scalability and flexibility of the invention under high-growth conditions, as well as its suitability for diverse investor profiles operating in tandem within a unified portfolio architecture.

FIG. 11 shows a hypothetical performance scenario for FOUR ICs with complementary objectives, assuming a 10% annual total return, in accordance with some embodiments. FIG. 11 illustrates an embodiment 1100 of a performance scenario in which a single investment portfolio is structured to simultaneously serve the complementary objectives of four investment companies (ICs): a Money Escalator IC 101A, a Loan-less Leverage IC 101B, a 15-Year Zero-Coupon IC 806, and a Fixed Rate IC 1106. The scenario assumes an initial combined investment $1,200,000, $500,000 invested each from the Money Escalator 101A and Loan-less Leverage 101B ICs, and $100,000 invested each from the Zero-Coupon 806 and Fixed Rate 1106 ICs, as shown in column 1107. The 15-year modeling period 509 assumes a portfolio compound annual growth rate (CAGR) of 10%, the U.S. equity markets average annual return, as indicated in 1101, and the Zero Coupon and Fixed Rate ICs rates are 1.7% based on prevailing interest rate and bond market conditions as of December 2020, when the FIG. 4 live portfolio commenced, with an additional 0.5% added to the 15 year U.S. Treasury Bond rate of 1.2%.

The Money Escalator IC 101A is structured to generate steadily growing dividend income, without reinvestment. Column 1108 presents projected annual dividend payments, which start at $26,830.00 in year 0 and increase to $95,294.66 by year-end 15. The dividend yield, displayed in column 1109, rises from 5.37% to 19.06%, reflecting dividend increases as a percentage of the initial principal amount of $500,000 in column 1107. Column 1110 presents the cumulative dividends received over the investment term, totaling $843,375.07. This structure allows the Money Escalator IC 101A to serve income-dependent investors seeking reliable, inflation-beating, continually increasing cash flows.

The Loan-less Leverage IC 101B has the objective of capital growth without dividend reinvestment. Its $500,000 initial investment (column 1107) grows to $2,473,420.20 by year-end 15 (column 1111), corresponding to a cumulative gain of 394.69% (1104) and an annualized return profile tapering from 20.18% in year 1 to 11.25% in year-end 15 (column 1102). These values reflect compounded growth under a 10% portfolio CAGR assumption, optimized for equity exposure and appreciation.

Column 1103 also shows the total value of the portfolio over time, excluding dividend reinvestment. The aggregate portfolio value grows from $1,000,000 to $3,073,452.20 by year-end 15, representing a cumulative gain of 179.40%. The scenario simultaneously models the presence of a Zero-Coupon IC 806 and a Fixed Rate IC 1106, each contributing $100,000 and receiving 1.7% fixed returns based on the Dec. 31, 2020 15 year U.S. Treasury bond rates of 1.2% plus 0.5%. The 15-Year Zero-Coupon IC is priced with a yield consistent with a 1.7% rate of return, resulting in a final maturity value of $128,769.88 805, while the Fixed Rate IC 1106 provides a consistent annual coupon payout of $1,700.00 1105 based on a fixed 1.7% rate applied to the principal. At the time of initial investment of the FIG. 4 portfolio, U.S. Treasuries with 15-year maturities had a 1.2% yield. These scenarios assume the zero coupon and fixed rate ICs pay 0.5%/year more interest than the Treasuries.

The embodiment combines investments from these four ICs within a single portfolio, and FIGS. 11, 12, and 13 illustrate the flexibility and sophistication of the system in managing multi-entity investments. The system's algorithms allocate the benefits, risks and obligations of assets across strategies in a way that optimizes the achievement of distinct investor mandates—including dividend yield, capital growth, zero-coupon compound interest accrual, and fixed-income distributions—by transforming a single portfolio's benefits, risks and obligations so that it is providing significantly more returns than conventional and customary separate investment vehicles. Column 1104 underscores the capital appreciation achieved by the growth-oriented IC 101B relative to the overall portfolio 1103, while column 1108 highlights the continually increasing dividend growth delivered to income-seeking participants. FIGS. 11, 12 and 13 demonstrate the system's robust capacity to synthesize income growth, equity appreciation, and fixed-return mandates across four distinct ICs through a shared portfolio. This embodiment validates the applicability of the invention to increasingly complex fund structures while achieving personalized outcomes for multiple stakeholders operating under different investment philosophies with distinct objectives.

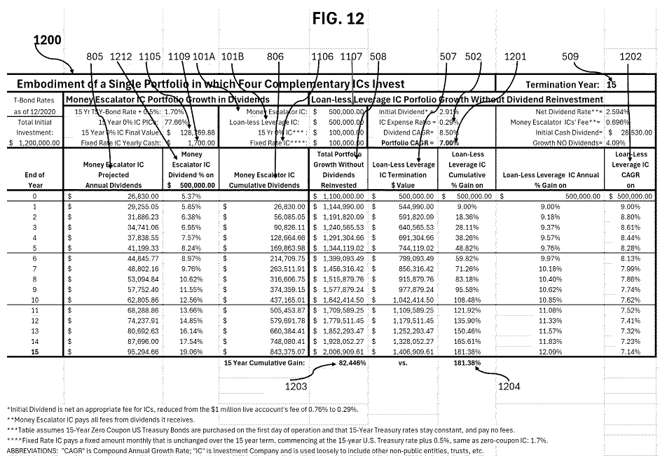

FIG. 12 shows a hypothetical performance scenario for the same FOUR ICs with complementary objectives, assuming a poor market period 7% annual total return, in accordance with some embodiments. FIG. 12 illustrates an embodiment 1200 of a performance scenario in which a single unified portfolio is jointly utilized by four complementary investment companies (ICs): a Money Escalator IC 101A, a Loan-less Leverage IC 101B, a 15-Year Zero-Coupon IC 1105, and a Fixed Rate IC 1106. This scenario models using conservative market assumptions with a compound annual growth rate (CAGR) of 7%, as shown in 1201. The total initial investment is $1,200,000, composed of $500,000 from each of the two primary equity-based ICs (101A and 101B) and $100,000 each from the zero-coupon 1105 and fixed-rate 1106 ICs, as detailed in column 1107.

The Money Escalator IC 101A is designed to generate growing annual dividend income over the 15-year term without reinvestment. Column 805 displays projected annual dividend payments starting at $26,830.00 and growing to $95,294.66 by year-end 15. The yield as a percentage of the initial $500,000 investment grows from 5.37% to 19.06%, as shown in column 1212. Column 806 shows cumulative dividends received over the term, totaling $843,375.07. This IC is optimized for income-dependent investors who value a steadily increasing cash flow while preserving capital.

The Loan-less Leverage IC 101B, simultaneously has the objective of capital appreciation without reinvestment of dividends. Its $500,000 allocation (column 1107) grows to $1,406,909.61 over the 15-year term, as presented in column 507. The cumulative gain of 181.38% is indicated in 1204, and annualized returns taper from 9.00% in year 1 to 7.14% in year 15 (column 1202). The portfolio supports investors seeking long-term capital growth exceeding the markets' gains while exposed to leveraged dividend-based portfolio's volatility.

Column 508 also presents the total portfolio value over time (excluding reinvested dividends), which increases from $1,000,000 to $2,006,991.46 over the 15-year horizon. This corresponds to a total portfolio cumulative gain of 82.446%, as shown in 1203. These results reflect the system's ability to generate value under more conservative return assumptions, while still fulfilling the distinct objectives of multiple investors.

In addition to the cash flow and capital growth oriented ICs, the portfolio also includes a 15-Year Zero-Coupon IC 1105 and a Fixed Rate IC 1106, each contributing $100,000 (shown in column 1107). The zero-coupon investment is priced to mature at $128,769.88 1105, based on 0.5% more interest than prevailing Treasury yields at initial investment of the FIG. 4 portfolio, and without any requirement to pay fees. The Fixed Rate IC offers consistent annual coupon payments of $1,700.00, as detailed in 1109, based on a fixed rate of 1.7% derived from 0.5% increase over similar maturity Treasury bonds at initial investment, and without any requirement to pay fees.

This embodiment highlights the invention's robust architecture for integrating multiple IC investment profiles within a single portfolio. The system uses algorithmic scoring, constraints, and rule-based logic to harmonize varying income, growth, and preservation goals, resulting from the structure of the investment, including rigorous selection of portfolio management. FIG. 12 reinforces the system's adaptability in lower-growth market environments and demonstrates the ongoing delivery of performance outcomes that achieve significantly more than available in customary structures, through shared single portfolio for four participating investment entities.

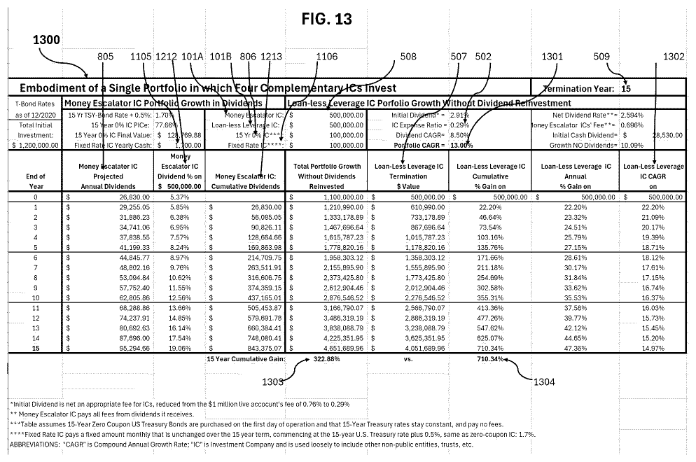

FIG. 13 shows a hypothetical performance scenario for the same FOUR ICs with complementary objectives, with this Figure assuming a 13% annual total return, in accordance with some embodiments. FIG. 13 illustrates an embodiment 1300 of a performance scenario in which a single unified investment portfolio is constructed to meet the complementary objectives of four investment companies (ICs): a Money Escalator IC 101A, a Loan-less Leverage IC 101B, a 15-Year Zero-Coupon IC 806, and a Fixed Rate IC 1106. This scenario models a high-growth market environment with an assumed compound annual growth rate (CAGR) of 13% for the portfolio, as reflected in 1301. The total initial investment is $1,200,000, with $500,000 each contributed by the Money Escalator and Loan-less Leverage ICs, and $100,000 each from the Zero-Coupon and Fixed Rate ICs (column 508).

The Money Escalator IC 101A receives projected annual dividends that grow consistently throughout the 15-year investment period. Column 805 shows annual dividend distributions increasing from $26,830.00 in year 0 to $95,294.66 in year-end 15, while column 1212 indicates a rise in dividend yield from 5.37% to 19.06%, based on the initial $500,000 investment (column 508). The cumulative dividends received, reported in column 1213, total $843,375.07 over the 15 year term. This configuration benefits investors with a focus on expanding income streams and inflation-beating returns.

Simultaneously, the Loan-less Leverage IC 101B has a capital appreciation objective without dividend reinvestment. The $500,000 investment grows to $4,051,689.96 by year-end 15, as displayed in column 507. Column 1304 shows a cumulative gain of 710.34%, and column 1302 presents the corresponding annual percentage returns tapering from 22.20% in year 1 to 14.97% in year 15. These results demonstrate the effectiveness of the invention's optimization system in generating long-term capital gains under aggressive market growth assumptions that are significantly more than obtained in customary portfolios.

Column 1303 also displays the growth of the single total portfolio (excluding reinvested dividends), which expands from $1,000,000 to $4,651,689.96 over the 15-year period. The cumulative portfolio gain is 322.88%, as indicated in column 1303. These values underscore the portfolio's performance in delivering differentiated outcomes, both in income and capital gains, across distinct ICs sharing a single portfolio.

The embodiment also integrates a 15-Year Zero-Coupon IC 1105 and a Fixed Rate IC 1105. The Zero-Coupon IC matures to $128,769.88 based on a fixed 1.7% annual yield and no interim cash flows, while the Fixed Rate IC provides a steady annual distribution of $1,700.00 (1105) throughout the term, offering principal protection with predictable income.

This embodiment demonstrates the invention's capability to dynamically allocate and optimize investments among multiple IC participants, and in highly favorable market conditions again significantly providing greater performance to the Money Escalator 101A and Loan-less Leverage 101B ICs, as well as the Zero Coupon 806 and Fixed Rate 1106 ICs. The invention's structure and mechanisms enable the concurrent achievement of income growth, aggressive capital appreciation, compounding of interest in the Zero Coupon IC, and fixed-income stability through a shared multi-manager portfolio. FIG. 13 reinforces the scalability of the system for complex fund structures and high-performance objectives, while maintaining individualized outputs for each participating entity through algorithmically managed rules and scoring priorities.

### Additional Description

The mechanics of the invention, thus, are understood more fully when viewing the series of performance scenarios in FIGS. 5 through 13 that use parameters taken from historical data, and coupled with performance data from the actual live portfolio shown in FIG. 4. The practical application is documented in the FIG. 5 through 13 scenario charts that depict hypothetical investment performance in markets that are normal (FIG. 5, FIG. 8, FIG. 11), poor (FIG. 6, FIG. 9, FIG. 12), and good (FIG. 7, FIG. 10, FIG. 13). The scenarios are for embodiments with two ICs (FIG. 5, FIG. 6, FIG. 7), three ICs (FIG. 8, FIG. 9, FIG. 10), and four ICs (FIG. 11, FIG. 12. FIG. 13) investing in a single portfolio 114 to optimize the complementary objectives of each IC. Note that in FIGS. 4 through 13, the same portfolio with the same 5 portfolio managers is used to generate each of the 9 scenarios. FIGS. 5 through 13 are examples of the CBDO 106 output as displayed 202 in the invention.

It is important to emphasize that in order to document that the invention enables significantly more returns, the nine scenarios' performance variables are taken from the live and ongoing portfolio (FIG. 4 table 400), as well as historical interest rate data on Dec. 31, 2020 when the scenarios commence. Enablement is documented using historical data and live portfolio performance data in FIGS. 4 through 13.

FIG. 4 table 400 provides data of the live portfolio illustrating how the invention's enablement of an outcome serves the purposes of embodiments with two complementary ICs 101A and 101B (See FIG. 5, FIG. 6, FIG. 7), three complementary ICs 101A, 101B, 806 (see FIG. 8, FIG. 9, FIG. 10), and four complementary ICs 101A, 101B, 806, 1106 (FIG. 11, FIG. 12, FIG. 13). In the three embodiments' nine tables of outcomes, we see how the mechanism works for two, three and four complementary objectives: 1) above average dividend yield that increases faster than inflation (for 101A the Money Escalator IC), 2) leveraged increase of principal over the long run without the use of derivatives, loans or margin (for 101B the Loan-less Leverage IC), 3) zero-coupon IC 806 priced to yield 1.7% compounding (0.5% more than a similar maturity U.S. Treasury Bond's 1.2% on Dec. 31, 2020), showing in FIGS. 8-10, and 4) fixed rate IC 1106 also priced to yield 1.7% (0.5% more than a similar maturity U.S. Treasury Bond's 1.2% on Dec. 31, 2020) showing in FIG. 11-13 as the $1,700 1105 annual fixed dividend on the $100,000 investment in the fixed rate IC 1106.

The single portfolio in the live ongoing portfolio in 400, is one embodiment of a portfolio, exemplifying those in which the ICs invest jointly 114, is managed by multiple portfolio managers, in this sample portfolio by five separate portfolio management firms that all seek stocks of companies with strong financials, high probability of dividend increases, and sector diversification. While each manager invests in only 40 to 60 stocks, the rarity of overlapping positions leads to diversification in holdings with more than 200 different companies' stocks in the portfolio (215 on May 31, 2024). Careful and rigorous portfolio manager selection allows the invention's users to have diverse security holdings and minimal overlap of securities by the five portfolio managers, which is a crucially important risk reduction strategy.

FIG. 4 is one example of the PMC 105 output on the invention's graphic user interface display 202.

The live portfolio whose characteristics and performance are shown in FIG. 4 is the same portfolio used in the 9 scenarios in FIGS. 5 through 13. Each IC receives above market returns with less market risk by receiving the appropriate features of that single portfolio. Note also that all fees are paid by the Money Escalator IC, so that the other ICs do not pay any fees. The invention, thus, is delivering substantially more return through the transformation of a common stock portfolio by allocating the benefits, risks and obligations unequally to the ICs that invest together in the single portfolio.

Though it is a long way to the 15-tear termination date 509 used in FIGS. 5 to 13, in FIG. 4 Chart 100 documenting the live portfolio, the Money Escalator IC's 101A objectives are being met already: the initial investment starts with a dividend yield of 2.91% 402, more than 50% above the usual S&P 500 dividend yields of the past twenty years (which rarely reached 2%). The dividend yield grew at a compound annual growth rate (CAGR) of 8.87% 401 from the live portfolio's beginning on Dec. 31, 2020 to Mar. 31, 2024, well above the inflation rate for those 3¼ years. And at this early stage, the Loan-less Leverage IC 101B also is meeting its objective of above average principal growth: since the entire portfolio's growth all goes to this IC, as of Mar. 31, 2024 its value has grown from $502,966 (which is $1,005,931.95/2; i.e., 406/2) to $837,779.5 (405 $1,340,745.53−$502,966=$837,779.5) (this is (405-406)/2), a cumulative gain of 66.6% in 3¼ years. The invention enables the complementary objectives of the ICs 101A and 101B through the rigorous selection of portfolio managers with 102, 103, 104, 105, and 106, a key component of the invention.

The roles of the portfolio modeling components of the invention, the PCC 104, PMC 105, and CDBO 106, are illustrated in FIG. 4 in the comparisons of the annual returns (407, 408, and 409), where we see that the portfolio managed by the five selected portfolio management firms has considerably less volatility that the S&P 500 Index. The Loan-less Leverage IC 101B benefits from this reduced downside volatility at termination date, as it reduces the probability of substantial loss, compared to leveraged portfolios that are in conventional and customary use. A rigorous selection of portfolio managers has provided a milder roller coaster for the ICs' portfolio compared to the S&P 500 Index. Simultaneously, the portfolio provided dividends that increased in every quarter, shown in the column under “Projected Annual Income” 410, while the income increased at a compound annual growth rate (CAGR) of 8.87% 401. Again, complementary objectives of ICs have a greater probability of being met with rigorous selection of portfolio managers with 102, 103, 104, 105, and 106, a key part of the invention's design and assembly of components.

In FIG. 4, the live portfolio starts with $1,005,931.95 404, and pays total annual fees of 0.76% 403, which is higher than the combined ICs' expected total fees of 0.29% 502. The live portfolio's performance compared to the S&P 500 (see 407, 408, 409) is calculated using market value at the start and end of each year, which is net after paying all expenses monthly at the rate of 1/12 of the annual fee of 0.76% 403. The performance figures in 400 demonstrate that the rigorous selection of portfolio managers in 102, 103, 104, 105, and 106 enables the invention to successfully achieve the ICs' complementary objectives.

FIG. 5 provides a table showing a scenario demonstrating how the invention enables substantially greater performance for two investor ICs 101A and 101B with complementary objectives. The Money Escalator IC 101A obtains a significant increase in income, while the Loan-less Leverage IC 101B uses leverage to obtain significantly greater capital gains without using the common leverage methods of derivatives, loans, or margin. More on how the invention accomplishes this, below, in the disclosure of Practical Application transformations.

Some aspects of the invention's systems, methods, and apparatus include the invention's unique assemblage of components for pursuit of substantially greater performance towards their objectives.

The CDBO 106 synthesized the output of the prior steps and integrates them with the terms of contracts that govern the way the ICs 101A and 101B will divide the single portfolio's 114 benefits and obligations using proprietary software, detailed below. FIGS. 5 through 13 are examples of CDBO output displayed on the invention's graphic user interface 202.

One preferred embodiment of the invention, illustrated in FIG. 1, provides for the union of these two ICs, 101A and 101B, which have complementary objectives, and joined using a collaborative arrangement with a supplemental management agreement, investing equal amounts in a single portfolio:
1) a Money Escalator IC 101A with the objective of significantly above average money flows that increase annually, with that IC terminating after 15 years by refunding the original share value to its shareholders.
2) a Loan-less Leverage IC 101B with the objective of obtaining significantly above-average increases in principal, with that IC keeping all assets remaining after the payoff and termination of the Money Escalator IC 101A.
   In this embodiment, the ICs each invest 50% of the funds for the total portfolio (see 101A and 101B, in FIG. 1, and FIG. 5-7).

In this embodiment of the invention, funds are invested in high quality equity securities providing the Money Escalator IC 101A above average dividend yields with continual increases. The Loan-less Leverage IC 101B has a greater likelihood of achieving above average long-term capital gains while taking less risk than ICs that use derivatives, loans, or margin to obtain similar returns.

The invention is useful in many ways, providing output that allows the selection of investment portfolios with potential for substantially higher investment performance, both as the single portfolio 114 that combines the investment of each of the multiple complementary ICs 101A and 101B, as well as for each IC on its own.

As a unit comprising multiple complementary ICs (such as 101A and 101B), the objective is achieved of providing flexibility and significantly superior performance not possible with existing investments. The invention transforms a portfolio of ordinary stocks by creating investment characteristics that are substantially more than ordinary stock portfolios, while the two ICs take on less risk than normally correlated with such superior gains. For example, unlike conventional income investments, if the ICs' market value is considered very high, investors who own both ICs 101A and 101B can sell the leveraged IC 101B to realize its capital gain and keep the continually increasing high-income IC 101A. It is normally not possible to separate the capital gain from the income stream of an income producing security. The separation of capital gains, so they may be realized, and still retain the above average income stream that continually increases, is a transformation of an income investment so that it provides a significant benefit to investors who own both Money Escalator 101A and Loan-less Leverage 101B ICs.

The embodiment's CDBO 106 GUI displays 202 in FIG. 5-7 demonstrate—the transformational power of the invention in details that follow.

The assumptions for performance variables used in the embodiment illustrations in FIG. 5 through FIG. 13 are from FIG. 4 chart 400 (discussed above), which shows actual performance of a similar live portfolio of high-quality stocks with above average dividends and dividend growth that commenced Dec. 31, 2020.

The probability of significantly increased performance is exemplified in this preferred embodiment's scenarios in FIGS. 5,6, and 7, consisting of the two ICs: 1) a Money Escalator IC 101A seeking extraordinary actual money flows that increase faster than inflation, and 2) a Loan-less Leverage IC 101B seeking extraordinary increases in principal. The Money Escalator IC 101A and Loan-less Leverage IC 101B have equal amounts invested in a single portfolio 114 of common stocks of above average financial strength, above average dividend yields, and a reasonably expected annual increase in dividends of 8.5%, slightly less than the 8.87% 401 currently received in the live portfolio 400. The Money Escalator IC 101A has a termination date of 15 years 509, at which time it receives its initial offering share price, and at that point in time the balance of the portfolio is then allocated to the Loan-less Leverage IC 101B. All dividends and interest go to, and all expenses are paid by, the Money Escalator IC 101A, and all increases in market value above the initial offering price are allocated to the Loan-less Leverage IC 101B. At the end of the 15-year term 509 of the Money Escalator IC 101A, its shareholders are paid the original issue value, and the remaining assets belong to the Loan-less Leverage IC 101B. The same variables are used in FIG. 6 and FIG. 7 except the total return (dividends+capital appreciation) of the portfolio's compound annual growth rate (CAGR) is varied: in FIG. 5 is 10% 501, in FIG. 6 is 7% 601, and in FIG. 7 is 13% 701. These assumptions of total return represent, respectively, average, poor and good long-term periods. In all three charts. 500, 600, and 700, the portfolio growth rate is calculated as the portfolio CAGR minus the dividend rate minus the fees, producing the portfolios' net growth rates (i.e., without dividends and the amounts paid in fees), respectively, in 500, 600, and 700 of 7.09% 514, 4.09% 602, and 10.09% 702.

Below and in FIG. 5 chart 500 is a description of one embodiment in which two separate ICs with complementary objectives invest in one equity portfolio. One IC's objectives include continually increasing money flows that are larger than a major equity market index's money flows (e.g., S&P 500). This IC is identified as the Money Escalator IC 101A. The second IC's objectives include increases in the principal at a rate substantially faster than a major market index (e.g., S&P 500) without the risks of margin, loans, options, futures, and foreign currencies. This IC is identified as the Loan-less Leverage IC 101B. The embodiment with 2 ICs substantially increases the performance on the investment for each IC, transforming the characteristics of the common stock portfolio in which they invest into greater characteristics that provide the opportunity for 9 practical applications shown in FIGS. 5 though 13 that result in substantially more for each IC, including upside with substantially reduced risk (reduced from the risks customarily and conventionally necessary for the returns achieved with the invention).

1) Practical Application Transformation #1a & #1b: REALIZING GAINS ON INCOME INVESTMENTS WITHOUT LOSING THE INCOME STREAM. Assume that an investor in both ICs 101A and 101B finds the ICs' single portfolio has appreciated to a point the investor considers overpriced.

a. The Loan-less Leverage IC 101B can be sold, and the continually increasing high income stream continues for the Money Escalator IC 101B. The gain in value of the Loan-less Leverage IC 101B is available without selling the source of above average money flows that increase continually. This is especially important for investors who want the above-average ever-increasing income stream, because until now they have not had the ability to sell stocks or bonds at high market values without losing those money-producing securities that increase in value.

b. The Loan-less Leverage IC 101B acts like an option on the price movement of the portfolio because its price appreciation trades in the open market separately from the Money Escalator IC 101A. Options, however, have much greater risk because of their far shorter terminations than the 15-year term in this embodiment 509.

2) Practical Application Transformation #2: INCREASING CAPITAL GAINS POTENTIAL. In this embodiment both ICs 101A and 101B contributed equal amounts of funds to the portfolio.

a. Because the Loan-less Leverage IC 101B has contributed half the investment, the price movement of the single portfolio results in a much larger price movement for the Loan-less Leverage IC's 101B investment, a price movement that is substantially more than for the single portfolio. For example, chart 500 shows that the single portfolio's market value has doubled 516 after 11 years, causing the Loan-less Leverage IC 101B market value to triple 517. That is a performance transformation providing significantly more gains to the Loan-less Leverage IC 101B. At termination after 15 years 509, the single portfolio's cumulative gain of 162% 515 causes the Loan-less Leverage IC 101B to be up 323% 513. These returns are the result of the portfolio's growth (without dividends) of 6.62% per year. In the 15-year period of poor total returns of 7% 601 assumed in FIG. 6, the Loan-less Leverage IC 101B has a cumulative gain of 167.9% 604 vs. 82% 603 for the market return on the single portfolio, again a transformation into significantly more returns. Note that the Loan-less Leverage IC's 101B CAGR in the poor market scenario 600 is 6.71% 605, which is close to the 7.09% 514 CAGR of the single portfolio in average markets (10% total return 501). This comparison makes an important point and deserves emphasis: in a poor market scenario 600 15-year period 509, the Loan-less Leverage IC 101B earns nearly the same CAGR as the total portfolio earns in an average market scenario 500. The transformation provides significantly more for the Loan-less Leverage IC 101B than expected in a poor market. FIG. 7 demonstrates the performance of the total portfolio in a good market period, assuming a 13% CAGR 701, and 9.62% CAGR 702 for the whole portfolio without dividends reinvested. With these assumptions over the 15-year period 509, the total portfolio has a cumulative gain of 323% 703 vs. 646% 704 for the Loan-less Leverage IC 101B. The total portfolio grew to nearly 4 times the $1 million investment, while the Loan-less Leverage IC 101B grew to nearly 8 times its $500,000 investment. The transformation is significantly more than earned in the general market in all 3 demonstrations of the embodiment.

b. The Loan-less Leverage IC 101B has margin-like leverage but without the risk of margin calls, allowing this IC to weather extreme volatility until the end of the 15-year term 509 of the Money Escalator IC 101A. The fact that the Loan-less Leverage IC 101B receives no dividends is like an “expense”, in this case like having margin interest expense that is fixed at the level of the dividends' current yield on the portfolio, a significant improvement as margin and loan rates are usually higher than dividend rates. This reduced “expense” boosts returns and reduces risk simultaneously.

c. Many institutional investors are prohibited from investing in derivatives, such as options and futures, and many are prohibited from leveraging through margin. The invention provides such investors with the Loan-less Leverage IC 101B, which may be useful instead of other more risky investments in their portfolios that are used as sources of potentially increased upside.

3) Practical Application Transformation #3: NO FEES FOR THE LOAN-LESS LEVERAGE IC 101B. As in all 9 scenarios in FIGS. 5 through 13, as in the embodiment's Practical Application transformations #1 and #2, the Money Escalator IC 101A pays all fees and expenses for the entire portfolio. That allows the Loan-less Leverage IC 101B to be managed for the lowest expense ratio possible: 0%. No IC has a lower expense ratio than the Loan-less Leverage IC 101B, as no index fund or managed portfolio operates with no fees or expenses. Fees are a source of drag on the upside, and a source of risk on the downside: no fees mean a great deal for the Loan-less Leverage IC 101B.

4) Practical Application Transformation #4: NET DIVIDENDS DOUBLED FOR THE MONEY ESCALATOR IC 101A. In the same embodiment discussed here in Practical Application transformations #1, #2 and #3, the Money Escalator IC 101A receives all the dividends from a portfolio, so that it receives double what it is owed based solely on the amount invested by the Money Escalator IC 101A. As a result, the dividend income on the portfolio is significantly larger for IC 101A than the total expenses, so the Money Escalator IC 101A has a stream of dividend income that is significantly more than available from the securities in the single total portfolio. FIG. 5 table 500 shows this embodiment, in which the Money Escalator IC 101A receives money flows that are significantly above average from a portfolio of high-quality securities, and without the risks associated with above average dividend yields. In 500 we used the Dec. 31, 2020 dividend rate of 2.91% 402 and assumed a lower level of expenses, down from 0.76% 403 for a $1 million live account, to 0.29% 502, which is common and appropriate for an IC. The Money Escalator IC 101A pays all of the 0.29% 502 expense ratio since it pays all expenses, resulting in a net yield of 2.62% 503 (2.91%-0.29%=2.62%) (this is (508-502)). In this embodiment, the Money Escalator IC 101A invested half the money in the single total portfolio and receives all dividends minus expenses, so the net rate of money flowing to the Money Escalator IC is 5.24% 504 per year (2.62%×2) (503×2). The net dividends flowing to the Money Escalator IC 101A are transformed to substantially more, doubling from 2.62% 503 to 5.24% 504 at the time of initial investment.

5) Practical Application Transformation #5: FLEXIBILITY OF LEGAL STRUCTURE. Prior multi-purpose funds were required to use a single legal structure, as they all were series funds created by management of a single security or portfolio. A Federal law passed in 1986 ended the use of such series funds. The invention allows for choice of legal structures (101C and 106) and thereby provides the ICs with more control of their operations and provides a way for them to thrive even with the 1986 law still in place. This is a major characteristic of the invention. The present invention creates flexibility in selection of the legal structures to bind separate ICs in their cooperative management of the single portfolio. This flexibility is achieved by the invention's novel and non-obvious starting point: separate ICs. By having separate ICs voluntarily joining to invest in a single portfolio, the present invention provides the ICs with the ability to select the legal structure for their cooperation in the management of the single portfolio. Examples of such legal structures include, but are not limited to, management agreements, joint ventures, partnerships, collaborative arrangements, domestic trusts and offshore trusts.

6) Practical Application Transformation #6: ANNUAL AND CUMULATIVE MONEY SIGNIFICANTLY MORE FOR THE MONEY ESCALATOR IC 101A. The Money Escalator IC 101A in Transformation examples #1 through #5 is receiving dividends from financially strong companies that are selected for their expected ability to increase their dividends continually. The leverage (of providing half the portfolio's funds and receiving all the portfolio's dividends minus fees) not only increases the dividends' current yield rate, but also provides greater cash increases every year, and much greater cumulative cash, as documented in table 500 in FIG. 5, which provides the following illustrative details.

A Money Escalator IC's 101A dividend yield increasing at 8.5%/year will more than triple in 15 years 509, raising the annual dividend rate on the original investment from 5.24% 504 to 17.81% 505. This is produced from the total single portfolio that has a net annual dividend that increases on the original investment from 2.62% 503 to 8.9% (half of 17.81% 505). In terms of money, the difference is very significant. For example, in FIG. 5 table 500 the Money Escalator IC 101A received dividends on its $500,000 506 investment as its net dividend yield compounded at 8.5% 507 (see 401) per year over 15 years 509, which results in the dividend more than tripling from $26,200 510 to $89,073 511. The Money Escalator IC's 101A increase of annual money flow at the end of 15 years 509 is $62,873 ($89,073 511-$26,200 510). At the end of 15 years 509 the continually increasing annual dividends produce a significantly larger cumulative amount of dividends than on a conventional portfolio, resulting in $802,558.72 in this scenario, where a conventional IC would have half of the net dividends: $401,229.36. In sum, after 15 years:

a) The Money Escalator IC 101A has money flows that are $62,873 more than the initial rate of $26,200 510, ending at $89,073 511.

b) The Money Escalator IC 101A has significantly more cumulative cash, gaining an additional $401,279 (($802,558/2) (512/2)) in cumulative net dividends over the 15 years 509.

The money flows and cumulative cash have been transformed by the invention into substantially more money for the Money Escalator IC 101A than available from high quality stock investment portfolios. And these substantially greater returns are achieved with much less risk than commonly employed to reach such returns.

7) Practical Application Transformation #7: SUSTAINABLE HIGH MONEY FLOWS FOR THE MONEY ESCALATOR IC 101A. The increases in the Money Escalator IC's 101A money flows are highly likely to be a secure source of real increasing income. The compound annual growth rate of dividends in the U.S. most often exceeds the U.S. rate of inflation. Historically, after large U.S. market declines, dividends proved to be quite resilient. The reliability of real dividends is demonstrated in a century of historical data combining U.S. inflation and dividend rates provided in the table below (note: “real” refers to “after the effects of inflation or deflation”). The invention increases the probability of sustainable spending from ever increasing dividends due to the computer-driven rigorous selection of portfolio managers to serve the complementary objectives of the ICs. It is expected that the invention's computer-driven rigorous selection of portfolio managers will improve on the results of the broad stock market, seen in the table below.

Total Returns vs. Sustainable Spending in U.S.
Bear Markets Over 30%, 1912-2011
S&P 500 from 1926; Shiller data before 1926
Source: Fundamentals, “Institutionalizing Courage,”
May 2012, Research Affiliates Newsletter, page 2

| | | | | Five Years Later | |
|---|---|---|---|---|---|
| | | Total Drawdown In: | | Dividend Growth | |
| | | Real Total | Real | | From Previous |
| Peak | Trough | Return | Dividends | From Trough | High |
| November '15 | November '17 | −40.9% | 1.6% | −3.1% | −1.5% |
| August '29 | June '32 | −79.3% | −24.7% | 73.4% | 38.2% |
| February '37 | March '38 | −50.0% | −14.0% | 11.6% | −4.1% |
| September '39 | April '42 | −40.1% | 1.8% | 16.2% | 18.3% |
| May '46 | February '48 | −35.7% | 7.5% | 99.5% | 114.5% |
| November '68 | June '70 | −35.5% | −7.4% | 8.4% | 0.3% |
| December '72 | September '74 | −51.9% | −3.9% | 42.9% | 37.3% |
| August '87 | November '87 | −30.2% | −6.6% | 40.2% | 30.9% |
| August '00 | September '02 | −47.2% | −7.1% | 66.2% | 54.5% |
| October '07 | February '09* | −51.8% | 4.0% | −4.1% | −0.2% |
| Average | 20.7 Mo | −46.3% | −2.7% | 35.1% | 28.8% |

*Subsequent five years is truncated to March 2012
Source: Research Affiliates based on data from Ibbotson and Shiller

8) Practical Application Transformation #8: HIGH SECURITY OF PRINCIPAL FOR MONEY ESCALATOR IC 101A. There is very little risk of losing any principal at the 15-year termination 509 of the Money Escalator IC 101A. In this embodiment in FIG. 5 to FIG. 7, at the end of the term in 15 years 509, the Money Escalator IC 101A receives the initial offering value, and the Loan-less Leverage IC 101B receives all remaining assets. For the Money Escalator IC 101A to lose money at the 15-year termination 509 the total single portfolio must be down in value to 50% of its initial offering value. Over the past 70 years, the U.S. stock market, without dividends reinvested, never had a loss ever in any 15-year period. From 1900 until today, even including the stock market crashes in 1929-1931 and 1936-1937, the U.S. stock market never lost half its value at the end of any 15-year period (source: Crestmont Research 2023 Stock Market Matrix, S&P 500 Index Only Nominal Returns without dividends). The rising income stream of the Money Escalator IC 101A is truly extraordinary considering its extraordinary security for the return of principal. The invention transforms the normally volatile source of dividends, stocks, into a bond-like AAA rated source of money due to its significantly great probability of returning all principal. It is quite likely to receive a AAA credit rating from the three major Rating Agencies (Moody's, S&P, Fitch), while U.S. Treasury debt receives only an AA+ credit rating from two of those three Rating Agencies. Less risk, significantly more returns. That is quite transformative.

9) Practical Application Transformation #9: COMPARATIVELY HIGH SECURITY FOR LOAN-LESS LEVERAGE IC 101B. The computer-driven rigorous selection of portfolio managers optimizes the complementary objectives in this embodiment by reducing portfolio volatility. In the live portfolio documented in FIG. 4 400, the rigorous selection of a portfolio with stocks of financially strong companies, and above-average dividend yields, leads to a portfolio that most often will have substantially lower volatility than the general stock market index, the S&P 500. As a result, the Loan-less Leverage IC 101B has a reduced probability of substantial loss at the 15-year termination date 509. The poor market scenarios shown in charts 600, 900 and 1200 assume 15-year CAGR (without dividends) of 3.62% 602, 3.3% 902, and 3.62% 1202. From 1932 through 2023, 90% of the 15-year periods had stock price performance (no dividends included) at these levels or higher. For the 15-year term 509, chart 600 shows a cumulative gain of 165% 604, chart 900 shows a cumulative gain of 165% 904, and chart 1200 shows a cumulative gain of 181% 1204. Again, the invention's computer-driven rigorous selection of portfolio managers is crucial to success in meeting the complementary objectives of the ICs and increases the probability of significantly more security of principal, while producing significantly more cumulative gains, double for the Loan-less Leverage IC 101B vs. the total portfolio. Looking at returns in poor markets (total return of 7%/year 601), we see gains for the Loan-less Leverage IC 101B of 165% 604 vs. 82% 603 for the portfolio. Looking at returns in an average market (total return of 10%/year 501) we see gains for the Loan-less Leverage IC 101B of 359% 513 vs. 179% 515 for the total single portfolio. In great markets (total return of 13%/year 701), we see gains for the IC 101B of 646% 704 vs. 323% 703 for the total single portfolio. These substantially greater increases in return also are documented in the scenarios with three ICs (FIG. 8-FIG. 10 charts 800-1000) and four ICs (FIG. 11-FIG. 13 charts 1100-1300).

FIG. 1A diagrams a second preferred computer-implemented embodiment of the invention, in which three ICs invest in a single portfolio 114, with performance scenarios in FIG. 8 chart 800, FIG. 9 chart 900, and FIG. 10 chart 1000. The assumptions are the same as in FIG. 5 chart 500, except that 9.1% of the money in the single portfolio is from a Zero-Coupon IC 806, and that 45.45% of the money in the single portfolio is from the Loan-less Leverage IC 802, and an equal 45.45% amount is from the Money Escalator IC 803.

To provide extraordinary security to the Zero-Coupon IC 806, this embodiment assumes that when funds are initially invested in the single portfolio, the portfolio's management immediately purchases zero-coupon U.S. Treasury bonds with a 0.5% increase in rate above the 15 Year Treasury rate (Dec. 31, 2020 rate of 1.2%+0.5%=1.7% 805), with a 15-year 509 maturity matching the termination date of the Money Escalator IC 101A.

Looking at the Loan-less Leverage IC's 101B returns, in poor markets (total return of 7%/year 601), we see gains of 165% 904 vs. 82% 903 for the total single portfolio. Looking at the Loan-less Leverage IC's 101B returns in an average market 800 (total return of 10%/year 501) we see gains of 359% 804 vs. 179% 803 for the total single portfolio. In great markets (total return of 13%/year 701), we see Loan-less Leverage IC 101B gains of 646% 1004 vs. 323% 1003 for the total single portfolio.

In this embodiment with three complementary ICs, all nine of the Practical Application Transformations cited above in the discussion of FIG. 1 are the same as described above in FIG. 5-7 for the embodiment with Two Complementary ICs. Note that the risk for the Money Escalator IC 101A at termination in 15 years 509 in FIG. 8 800 is the same as in FIG. 5 500: the equity portfolio's investments must decline 50% from the initial offering value to inflict a loss on the Money Escalator IC 101A at the 15-year termination 509. The risk remains the same in this embodiment because the 15-year Treasury bond is purchased at the time of initial investment for the zero-coupon IC 806.

10) Practical Application Transformation #10: NO FEES FOR THE ZERO-COUPON IC 806. The Money Escalator IC 101A pays all fees and expenses for the entire portfolio in all three embodiments illustrated in this disclosure. That allows the zero-coupon IC to be managed for the lowest expense ratio possible: 0%. No IC has a lower expense ratio than the zero-coupon IC, as no IC or managed portfolio operates with no fees or expenses. No fees for an investment create a higher return and reduce risk.

11) Practical Application Transformation #11: SUBSTANTIALLY MORE SECURITY FOR THE ZERO-COUPON IC. At termination 509, the zero-coupon IC 806 is paid first, the Money Escalator IC 101A second, and the Loan-less Leverage IC 101B keeps all remaining assets. As a result, the total portfolio would have to be less than 10% of the total initial investments, which has never happened in any 15-year period in U.S. markets. The result is a zero-coupon bond-like return that is 0.5% higher than U.S. Treasury bonds with higher security due to a likely higher credit rating: it is most likely to be rated AAA by all agencies, while the U.S. Treasury bonds have a AA+ rating from two rating agencies, Fitch and Standard & Poor's.

In a third preferred computer-implemented embodiment of the invention shown in FIG. 1B, four ICs with complementary objectives invest in a single portfolio 114, illustrated in FIG. 1B diagram 100B, with performance scenarios in FIG. 11 chart 1100, FIG. 12 chart 1200, and FIG. 13 chart 1300. The assumptions are the same as in FIG. 8 chart 800, except that 8.33% of the money in the single portfolio 114 is for a Fixed Rate IC 1106 paying monthly dividends using the same rate of 1.7% 805 as the 15-year Zero-Coupon IC 806. The Fixed Rate IC 1106 pays no fees and has its initial principal returned at the end of the same 15-year term 509 when the Money Escalator IC 101A and the Zero-coupon IC 806 receive the return of their initial principal. The Fixed Rate IC 1106 is the fourth IC in this embodiment and is with the same three ICs 101A, 101B, 806, described in embodiments #1 and #2, with 8.33% from the Zero-coupon IC 806, 41.67% from the Loan-less Leverage IC 101B, and an equal 41.67% amount from the Money Escalator IC 101A.

The Fixed Rate IC 1106 has a negligible level of risk, as the total portfolio would need to have a loss greater than 80% at the end of the 15-year term 509, which has never happened in any 15-year period in the U.S. stock market, even when including the Stock Market Crash of 1929-1931. Given the history of 15-year periods in the U.S. stock market, it is reasonable to assume that a AAA credit rating would be assigned to the Fixed Rate IC 1106, while the U.S. Treasury bonds have a AA+ rating from two rating agencies, Fitch and Standard & Poor's. Higher return than U.S. Treasury debt with less credit risk is a transformation that provides significantly more than the U.S. Treasury bond.

In this third embodiment with four ICs, the percentage investment allocations assumed from each of the four ICs 101A, 101B, 806, 1106 changes the risk level for the Money Escalator IC 101A and the Loan-less Leverage IC 101B. At the end of the 15-year term 509, the Money Escalator IC 101A receives the return of all its initial investment, which requires the total portfolio to have decline to 60% of its initial offering value at the 15-year termination 509. In the U.S. stock market, all 15-year periods have positive returns once they are past the time of the 1929-1931 stock market crash. Nominal Returns for the U.S. stock market without dividends reinvested show that the only 15-year periods which would produce losses for the Money Escalator IC 101A in the 4 IC scenarios are those ending in 1942 (15% loss), 1943 (15% loss), and 1944 (34% loss) (source: Crestmont Research Stock Market Matrix: S&P 500 Index Only Nominal Returns, 1900-2023).

The Loan-less Leverage IC 101B has more risk in this third embodiment than in the other two embodiments, as it will have no value if the total portfolio has a loss that brings it down to 60% of its initial offering value at the end of the 15-year term 509. Between 1900 and 1945 there are negative returns in nine 15-year periods; the worst two had a 60% loss (1942 and 1943), and the third worst had a 44% loss (1944), and these are the only 15-year periods that would make the Loan-less Leverage IC 101B worthless. Over the past 124 years (starting in 1900) in the U.S. stock market, the 15-year time periods have losses in 7.3% of the time, which is a 92.7% rate of positive returns (source: Crestmont Research Stock Market Matrix: S&P 500 Index Only Nominal Returns, 1900-2023). It is worth noting that in the past 75 years there are no 15-year periods in which the U.S. stock market has a loss, which means that all four ICs would have had positive returns in the past ¾ of a century. If instead of the leverage provided by the invention, an investor leveraged with a margin loan that was 50% of the investment portfolio, then any time the market value of the portfolio declined 50% the lender would call in the margin loan and force the margined portfolio to have a 100% loss. U.S. stock market declines of 50% happen periodically, for example, between 2000 and 2009 there were two declines of 50%. The invention provides greater safety than margin for leveraged stock investments such as the Loan-less Leverage IC 101B. All eleven of the Practical Application Transformations cited above are the same for FIG. 11 chart 1100, FIG. 12 chart 1200, and FIG. 13 chart 1300 for four Complementary ICs 101A, 101B, 806, 1106. There are two additional Practical Application Transformations for the Fixed Rate IC 1106 that invests to receive a fixed dividend rate for the term and then receives a return of the initial investment amount at termination in 15 years 509.

12) Practical Application Transformation #10: NO FEES FOR THE FIXED RATE IC 1106. The Money Escalator IC 101A pays all fees and expenses for the entire portfolio. That allows the Fixed Rate IC 1106 to be managed for the lowest expense ratio possible: 0%. No IC has a lower expense ratio than the Fixed Rate IC 1106, as no IC or managed portfolio operates with no fees or expenses. No fees mean the Fixed Rate IC 1106 has more returns and less risk.

13) Practical Application Transformation #11: SUBSTANTIALLY HIGHER SECURITY FOR THE FIXED RATE IC 1106. The Fixed Rate IC 1106 gets its dividends before any are paid to the Money Escalator IC 101A. Since the Fixed Rate IC 1106 is 9.1% of the stock portfolio, there would have to be a 90% cut in the portfolio's dividend income to threaten a reduction in this IC's 1106 dividends, making the dividend cash flow extraordinarily secure. At termination in 15 years 509, the Fixed Rate IC 1106 is paid second (after 10% of assets go to the Zero-Coupon IC 806), the Money Escalator IC 101A is paid third, and the Loan-less Leverage IC 101B keeps all remaining assets. As a result, the portfolio would have to be less than 20% of the total initial investments, which has never happened in any 15-year period in U.S. markets. The result is a Fixed Rate bond-like return that is 0.5% higher than a U.S. Treasury bond, and quite likely to have a higher level of security, and perhaps a higher credit rating: it is most likely to be rated AAA by all agencies, while the U.S. Treasury bonds have a AA+ rating from two rating agencies, Fitch and Standard & Poor's. Such high security is provided for this source 1106 of dividend income. The inventor is unable to find any preferred stocks with an equally secure level of guarantees for dividends coupled with the return of the initial investment after 15 years 509.

Notice that in all three embodiments, as seen in each embodiment's three market scenarios in FIGS. 5 through 13 (poor, normal and good markets), the Loan-less Leverage IC's 101B gains are about double the gains on the total single portfolio. In the third embodiment (with the Fixed Rate IC 1106 as the fourth IC), the gains are larger than double. The nine market scenarios (FIG. 5-FIG. 13) document the transformation to significantly more returns of a blue-chip dividend-oriented stock portfolio, through the invention's split of benefits to suit the complementary objectives of each IC 101A, 101B, 806, 1106, to provide substantially more returns to the Loan-less Leverage IC 101B with considerably less risk than other forms of leverage.

Also notice that in all three embodiments, as seen in each embodiment's three market scenarios in FIGS. 5 through 13 (poor, normal and good markets), the Money Escalator IC's 101A net dividend rate (after paying all fees) is about double the dividend rate on the total portfolio. In the third embodiment (with the Fixed Rate IC 1106), the dividends are more than doubled. The nine market scenarios (FIG. 5-FIG. 13) document the transformation of a blue-chip dividend-oriented stock portfolio, through the invention's splitting of benefits to suit the complementary objectives of each IC 101A, 101B, 806, 1106, to provide substantially more returns to the Money Escalator IC 101A with considerably less risk than the risks taken by high-yield bonds and stocks.

For each of these embodiments diagrammed in FIG. 1, FIG. 1A, FIG. 1B of the model and methodologies of the invention described above, key features may not be otherwise available to investors of ICs seeking to receive above average returns with below average risk relative to conventional choices. Therefore, the IC investors may take advantage not just of the unique outcomes of the invention but also may use the invention as an alternative to other investments, as seen in the investment solutions in these embodiments.

The inventor contemplates in some embodiments, the exclusion of certain steps, features, elements, and components that are set forth in this disclosure even when such are identified as preferred or preferable.

Although the present invention has been described with reference to specific exemplary embodiments, it will be evident that various modifications and changes may be made to these embodiments without departing from the broader spirit and scope of the invention. Accordingly, the specifications and drawings are to be regarded in an illustrative rather than a restrictive sense. In sum, due to the unique mechanics of the invention's computer-driven system, method, and apparatus, the investors' returns on their investments are transformed into significantly more returns with significantly less risk than normally required for such extraordinary returns. The CDBO 106 GUI displays 202 in the nine scenarios in FIG. 5-FIG. 13 illustrate the thirteen useful transformations described above, all providing significantly more than normally possible with significantly less risk than normally required for such returns, and attest to the value of the invention's combination of a system, method and apparatus for rigorously computer-driven portfolio manager selection with a system, method and apparatus for cooperative management of a single portfolio for the mutual advantage of multiple ICs in optimizing their complementary objectives.

No existing investment companies provide anything like the invention's transformation, exemplified in this disclosure's embodiments, of a common stock portfolio to create a source of substantially more returns with less risk than commonly needed to obtain substantially greater returns.

It should be understood at the outset that, although exemplary embodiments are illustrated in figures and described below, the principles of the present disclosure may be implemented using any number of techniques, whether they are currently known or not. The present disclosure should in no way be limited to the exemplary implementations and techniques illustrated in the drawings and described in the disclosures above and below.

Additionally, unless otherwise specifically noted, articles depicted in the drawings are not necessarily drawn to scale. In addition, well-known structures, circuits and techniques have not been shown in detail in order not to obscure the understanding of this description. The detailed descriptions are not to be taken in a limiting sense.

As used herein, the term “computer” is meant to encompass a workstation, personal computer, digital assistant, wireless telephone, or any other suitable computing device including a processor a computer readable medium up which computer readable program code (including instructions and/or data) may be disposed, and a user interface. Terms such as “server,” “application,” “engine,” “component,” “module,” “control components/devices,” “messenger component or “service,” and the like are intended to refer to a computer-related entity, including hardware or a combination of hardware and software. Moreover, the various computer-related entities may be located on one computer and/or distributed between two or more computers, in one or more locations.

The system, method, and apparatus embodying the present invention can be programmed in any suitable language and technology, such as, but not limited to: Assembly Languages, C, C++; Visual Basic; Java; VBScript; Jscript; Node.js; BCMAscript; DHTM1; XML and CGI. Alternative versions may be developed using other languages including Hypertext Markup Language (HTML), Active ServerPages (ASP) and Javascript. Any suitable database technology can be employed, such as, but not limited to, Microsoft SQL Server or IBM AS 400, as well as big data and NoSQL technologies, such as, but not limited to, Hadoop or Microsoft Azure.

The system, method, and apparatus are implemented in various computing environments. For example, the present invention may be implemented on a conventional IBM PC or equivalent, multi-nodal system (e.g., LAN) or networking system (e.g., internet, WWW, wireless web). All programming and data related thereto are stored in computer memory, static or dynamic or non-volatile, and may be retrieved by the user in any conventional computer storage, display (e.g., CRT, flat panel LCD, plasma, etc.) and/or hardcopy (i.e., printed) formats. The programming of the present invention may be implemented by one skilled in the art of computer systems and/or software design.

### EXAMPLES

Clause 1. A computer-implemented system for generating and presenting investment portfolio options for use by a plurality of investment entities having different investment objectives, the computer-implemented system comprising: one or more processors; and one or more memories storing instructions that, when executed by the one or more processors, cause the one or more processors to perform operations comprising: receiving, from one or more data sources, investment-related data associated with one or more securities and one or more existing investment portfolios; processing the investment-related data to identify one or more characteristics of the one or more securities and one or more portfolios, the one or more characteristics comprising at least one of: yield, growth rate, or volatility; evaluating, via a portfolio modeling engine executed by the one or more processors, a plurality of individual portfolios and combinations of portfolios using one or more multi-factor optimization algorithms, the evaluation performed in real-time and based on user-configurable criteria provided by the plurality of investment entities; generating, by the computer-implemented system, one or more dynamically ranked portfolio configurations for complementary investment objectives across the plurality of investment entities, wherein the ranking comprises a weighted scoring computation based on the one or more identified characteristics; generating, via a graphical user interface, interactive visual outputs comprising at least one portfolio performance metric, a ranking indicator, or an alternative investment allocation customized for each of the plurality of investment entities; and outputting, via the graphical user interface, a legal structuring recommendation or an investment agreement parameter configured to support cooperative investment by two or more investment entities in a single portfolio under one or more predefined allocation rules.

Clause 2. The computer-implemented system of clause 1, wherein the portfolio modeling engine is configured to simulate portfolio behavior with one or more fundamental risk factors and under one or more stress scenarios by applying a historical market event to a current portfolio holding.

Clause 3. The computer-implemented system of clause 1, wherein the one or more multi-factor optimization algorithms apply a user-defined weighting value to each of the one or more identified characteristics to generate a suitability score for each portfolio configuration.

Clause 4. The computer-implemented system of clause 1, wherein the graphical user interface is further configured to display, for each investment entity, a recommended investment allocation and an expected performance range based on the ranked portfolio configurations.

Clause 5. The computer-implemented system of clause 1, wherein the legal structuring recommendations include identification of one or more investment vehicles or contractual structures suitable for joint management of a single portfolio by the plurality of investment entities.

In some embodiments, the recommendations further include evaluation of collaborative arrangements enabling the investment entities to jointly manage the portfolio and share in its economic benefits and obligations. The contractual structure facilitates the division of income and capital gains tax liabilities in alignment with the intended financial strategies, allowing income allocations to be taxed under the Money Escalator framework and capital gains allocations under the Loan-less Leverage framework. It is possible that the choice of contractual arrangement distinguishes operational control and benefit sharing from traditional ownership models, similar to how mutual fund investors participate in returns without direct ownership or governance of portfolio assets.

Clause 6. The computer-implemented system of clause 1, wherein the computer-implemented system is further configured to generate alerts or recommendations when the ranked portfolio configurations fall below predefined performance thresholds for any of the investment entities.

Clause 7. The computer-implemented system of clause 1, wherein the investment-related data includes live or near-real-time market feeds from at least one of a trading exchange, pricing service, regulatory database, or portfolio manager platform.

Clause 8. The computer-implemented system of clause 1, wherein the portfolio configurations are continuously re-ranked in response to changing market conditions, updated data feeds, or revised user constraints.

Clause 9. The computer-implemented system of clause 1, wherein the portfolio modeling engine further includes a scenario testing module configured to compute projected money flows and capital appreciation under multiple market volatility models.

Clause 10. The computer-implemented system of clause 1, wherein the graphical user interface supports side-by-side visual comparison of at least two portfolio configurations across performance metrics, allocation breakdowns, and legal structuring options.

Clause 11. The computer-implemented system of clause 1, wherein the computer-implemented system further includes a compliance verification module configured to validate that each proposed portfolio configuration complies with applicable regulatory constraints or fund governance rules.

Clause 12. The computer-implemented system of clause 1, wherein each investment entity is enabled to independently define one or more termination conditions, and wherein the computer-implemented system modifies portfolio allocation rules accordingly.

Clause 13. The computer-implemented system of clause 1, wherein the dynamically ranked portfolio configurations include metadata describing each underlying portfolio manager's historical performance, tenure, and professional credentials.

Clause 14. The computer-implemented system of clause 1, wherein the user interface includes input fields enabling investment entities to assign priority scores to one or more performance characteristics, including current yield, standard deviation, beta, or Sharpe ratio.

Clause 15. The computer-implemented system of clause 1, wherein portfolio evaluation includes determining a degree of correlation among portfolio holdings and generating diversification indices to support allocation decisions.

Clause 16. A computer-implemented method, performed by one or more processors of a computing system configured with memory, for generating and displaying optimized investment portfolio options for a plurality of investment entities with complementary investment objectives, the method comprising: receiving, by the computing system from one or more external data sources, investment-related data associated with a plurality of securities and existing portfolios, including live or historical pricing data, ratings, or performance metrics; processing, by the computing system, the investment-related data to identify one or more security- and portfolio-level characteristics, the characteristics comprising at least one of: yield, volatility, Sharpe ratio, alpha, beta, or manager tenure; receiving, via a graphical user interface, user-defined input data comprising criteria and priority weightings from each of the plurality of investment entities; executing, by the computing system, a portfolio modeling engine that applies multi-factor optimization algorithms to evaluate individual and multi-manager portfolio combinations against the input data; generating, by the computing system, a ranked list of candidate portfolio configurations optimized to satisfy complementary objectives of the investment entities, each configuration stored in system memory and linked to corresponding metadata; verifying, by a compliance module executing on the computing system, that each ranked portfolio configuration conforms to legal or regulatory constraints applicable to pooled investment vehicles; and presenting, via the graphical user interface, an interactive display of portfolio options, performance rankings, risk metrics, and legal structuring recommendations enabling cooperative investment by the investment entities in a single shared portfolio; and wherein the method integrates one or more financial modeling operations into a computer-based platform to transform disparate financial data and one or more user-defined constraints into one or more legally actionable portfolio configurations.

Clause 17. The computer-implemented method of clause 16, wherein simulating portfolio performance comprises applying one or more fundamental risk factors and one or more historical economic scenarios to a current holding, including at least one of: a past market crash, an interest rate spike, or an inflationary period, to generate stress test outputs rendered in the graphical user interface.

Clause 18. The computer-implemented method of clause 16, wherein each dynamically ranked portfolio configuration is scored using a rule-based algorithm that weights at least three user-specified factors and produces a composite suitability score displayed next to each configuration.

Clause 19. The computer-implemented method of clause 16, wherein the graphical user interface is further configured to render interactive sliders or toggles that allow each investment entity to adjust a priority weighting and to regenerate one or more rankings.

Clause 20. The computer-implemented method of clause 16, wherein presenting the ranked portfolio configurations further comprises generating at least one of a downloadable legal framework template, including an investment percentage, a termination condition, or a fee apportionment between each of the investment entities. 1. 12. 13.

Clause 21. A non-transitory computer-readable medium comprising program code that is executable by one or more processors to perform operations including:
for displaying, on a user interface, single portfolio alternatives, to be utilized by two or more investment companies (ICs) that increases a likelihood of achieving a complementary objective of two or more investment companies (IC), the one or more processors comprising:
a data aggregation module on the non-transitory computer-readable medium operating to: receive data in multiple formats from multiple computers, the data being associated with the complementary objectives of the ICs.
obtain a full securities holdings in existing portfolios, to identify those portfolios that address the complementary objectives of each IC using one or more characteristics of the securities identified in prior data, including one or more other characteristics being selected from the group consisting of CAGR, volatility, beta, alpha, correlation to corresponding indices, correlation to each other, Sharpe ratio, standard deviation, R², or tenure of portfolio managers; and
configure on a user interface, on a non-transitory computer-readable medium that is joined to both data aggregation methods, a dynamic tool to display one or more combinations of the portfolios to provide output that addresses the complementary objectives of the two or more ICs, including measures of characteristics such as volatility, beta, alpha, configures on a user interface current yield, yield CAGR, correlation to corresponding indices, correlation to each other, Sharpe ratio, standard deviation, R², and tenure of portfolio managers;
a graphical representation of the portfolios that optimize both actual money flows and actual increases in principal, with other measures of portfolio characteristics such as volatility, beta, alpha, correlation to appropriate indices, correlation to each other, Sharpe ratio, standard deviation, R²;
a graphical representation of combinations of the portfolios that optimize both actual money flows and actual increases in principal, with other measures of portfolio characteristics such as volatility, beta, alpha, correlation to appropriate indices, correlation to each other, Sharpe ratio, standard deviation, R², and tenure of portfolio managers;
outcome data of the performance of single portfolios and combinations of portfolios; and
in which the non-transitory computer-readable medium is further configured to dynamically rank the single portfolios and combinations of portfolios using alternative weightings of selected portfolio characteristics.

Clause 22. The non-transitory computer-readable medium of claim 21, wherein the one or more processors to dynamically display on a graphic representation numerous portfolio orderings based on various prioritizations of characteristics.

Clause 23. The non-transitory computer-readable medium of claim 21, wherein the one or more processors to display a graphical representation of the combinations of the portfolios.

Clause 24. The non-transitory computer-readable medium of claim 21, wherein the one or more processors has input of percentage investment in the single portfolio by each of the complementary ICs.

Clause 25. The non-transitory computer-readable medium of claim 21, wherein the one or more processors has input of termination date, if any, of any of the complementary ICs.

Clause 26. The non-transitory computer-readable medium of claim 21, wherein the one or more processors to display graphical representation of investment percentage for each IC relative to a total portfolio showing alternative optimizations based on variations priorities of investment factors;
processors continually repeating all steps with GUI output;
enabling each IC to invest in one or more single portfolio amounts relative to the total investments that meet one or more parameters of the complementary objectives of each IC; and
depositing in the single portfolio the amounts that meet the parameters of each IC.

Clause 27. The non-transitory computer-readable medium of claim 21, further comprising a graphical dashboard is configured to display multiple investment portfolios and combinations of portfolios.

Clause 28. The non-transitory computer-readable medium of claim 21, wherein information is about the investment portfolios.

Clause 29. The non-transitory computer-readable medium of claim 21, further comprising a graphical dashboard is configured to compare multiple portfolios and combinations of portfolios.

Clause 30. The non-transitory computer-readable medium of claim 21, further comprising a principal oriented ICs pay no fees and receive no money flows until termination date.

Clause 31. The non-transitory computer-readable medium of claim 21, wherein one or more calculations are made of one or more fees and expenses and the fees and the expenses are taken from a single portfolio's incoming money and paid.

Clause 32. The non-transitory computer-readable medium of claim 21, wherein the one or more processors to allocate net money flows, after payment of fees and expenses, to a money-flow ICs until a termination date.

Clause 33. The non-transitory computer-readable medium of claim 21, wherein the one or more processors are configured to, upon a termination date, cause one or more money-flow investment components (ICs) to cease operation, and facilitate distribution to IC investors of their original offering market value per IC.

Clause 34. The non-transitory computer-readable medium of claim 21, wherein the one or more processors are configured to, after a termination date, allocate all assets to one or more principal-oriented investment components (ICs) and debit all fees and expenses from the single portfolio.

Clause 35. The non-transitory computer-readable medium of claim 21, wherein, from a termination date of a money-flow IC, one or more principal investment components (ICs) retain at least one asset and are configured to pay a fee or a expense in proportion to a respective asset value.

Modifications, additions, or omissions may be made to the systems, methods, and apparatus described herein without departing from the scope of the disclosure. For example, the components of the systems and apparatuses may be integrated or separated. Moreover, the operations of the systems and apparatuses disclosed herein may be performed by more, fewer or other components and the methods described include more, fewer, or other steps. Additionally, steps may be performed in any suitable order. It should be further understood that any of the features described with respect to one of the embodiments described herein may be similarly applied to any of the other embodiments described herein without departing from the scope of the present invention.

The instant inventor has built a new technical infrastructure of various specialized computers performing complex data aggregation, calculations, analysis, and modeling, comprising one or more processors, one or more memories, including instructions executable by the one or more processors to cause the one or more processors to perform operations, described above and below.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted by those skilled in the art, and that such modifications and variations are considered to be within the scope of this invention as defined by the appended claims.

Specific details are given in the preceding and following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

The computer-implemented illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A computer-implemented system for generating and presenting investment portfolio options for use by a plurality of investment entities having different investment objectives, the computer-implemented system comprising:
one or more processors; and
one or more memories storing instructions that, when executed by the one or more processors, cause the one or more processors to perform operations comprising:
receiving, from one or more data sources, investment-related data associated with one or more securities and one or more existing investment portfolios;
processing the investment-related data to identify one or more characteristics of the one or more securities and one or more portfolios, the one or more characteristics comprising at least one of: yield, growth rate, or volatility;
evaluating, via a portfolio modeling engine executed by the one or more processors, a plurality of individual portfolios and combinations of portfolios using one or more multi-factor optimization algorithms, the evaluation performed in real-time and based on user-configurable criteria provided by the plurality of investment entities;
generating, by the computer-implemented system, one or more dynamically ranked portfolio configurations for complementary investment objectives across the plurality of investment entities, wherein the ranking comprises a weighted scoring computation based on the one or more identified characteristics;
generating, via a graphical user interface, interactive visual outputs comprising at least one portfolio performance metric, a ranking indicator, or an alternative investment allocation customized for each of the plurality of investment entities; and
outputting, via the graphical user interface, a legal structuring recommendation or an investment agreement parameter configured to support cooperative investment by two or more investment entities in a single portfolio under one or more predefined allocation rules.

2. The computer-implemented system of claim 1, wherein the portfolio modeling engine is configured to simulate portfolio behavior with one or more fundamental risk factors and under one or more stress scenarios by applying a historical market event to a current portfolio holding.

3. The computer-implemented system of claim 1, wherein the one or more multi-factor optimization algorithms apply a user-defined weighting value to each of the one or more identified characteristics to generate a suitability score for each portfolio configuration.

4. The computer-implemented system of claim 1, wherein the graphical user interface is further configured to display, for each investment entity, a recommended investment allocation and an expected performance range based on the ranked portfolio configurations.

5. The computer-implemented system of claim 1, wherein the legal structuring recommendations include identification of one or more investment vehicles or contractual structures suitable for joint management of a single portfolio by the plurality of investment entities.

6. The computer-implemented system of claim 1, wherein the computer-implemented system is further configured to generate alerts or recommendations when the ranked portfolio configurations fall below predefined performance thresholds for any of the investment entities.

7. The computer-implemented system of claim 1, wherein the investment-related data includes live or near-real-time market feeds from at least one of a trading exchange, pricing service, regulatory database, or portfolio manager platform.

8. The computer-implemented system of claim 1, wherein the portfolio configurations are continuously re-ranked in response to changing market conditions, updated data feeds, or revised user constraints.

9. The computer-implemented system of claim 1, wherein the portfolio modeling engine further includes a scenario testing module configured to compute projected money flows and capital appreciation under multiple market volatility models.

10. The computer-implemented system of claim 1, wherein the graphical user interface supports side-by-side visual comparison of at least two portfolio configurations across performance metrics, allocation breakdowns, and legal structuring options.

11. The computer-implemented system of claim 1, wherein the computer-implemented system further includes a compliance verification module configured to validate that each proposed portfolio configuration complies with applicable regulatory constraints or fund governance rules.

12. The computer-implemented system of claim 1, wherein each investment entity is enabled to independently define one or more termination conditions, and wherein the computer-implemented system modifies portfolio allocation rules accordingly.

13. The computer-implemented system of claim 1, wherein the dynamically ranked portfolio configurations include metadata describing each underlying portfolio manager's historical performance, tenure, and professional credentials.

14. The computer-implemented system of claim 1, wherein the user interface includes input fields enabling investment entities to assign priority scores to one or more performance characteristics, including current yield, standard deviation, beta, or Sharpe ratio.

15. The computer-implemented system of claim 1, wherein portfolio evaluation includes determining a degree of correlation among portfolio holdings and generating diversification indices to support allocation decisions.

16. A computer-implemented method, performed by one or more processors of a computing system configured with memory, for generating and displaying optimized investment portfolio options for a plurality of investment entities with complementary investment objectives, the method comprising:
receiving, by the computing system from one or more external data sources, investment-related data associated with a plurality of securities and existing portfolios, including live or historical pricing data, ratings, or performance metrics;
processing, by the computing system, the investment-related data to identify one or more security- and portfolio-level characteristics, the characteristics comprising at least one of: yield, volatility, Sharpe ratio, alpha, beta, or manager tenure;
receiving, via a graphical user interface, user-defined input data comprising criteria and priority weightings from each of the plurality of investment entities;
executing, by the computing system, a portfolio modeling engine that applies multi-factor optimization algorithms to evaluate individual and multi-manager portfolio combinations against the input data;
generating, by the computing system, a ranked list of candidate portfolio configurations optimized to satisfy complementary objectives of the investment entities, each configuration stored in system memory and linked to corresponding metadata;
verifying, by a compliance module executing on the computing system, that each ranked portfolio configuration conforms to legal or regulatory constraints applicable to pooled investment vehicles; and
presenting, via the graphical user interface, an interactive display of portfolio options, performance rankings, risk metrics, and legal structuring recommendations enabling cooperative investment by the investment entities in a single shared portfolio; and
wherein the method integrates one or more financial modeling operations into a computer-based platform to transform disparate financial data and one or more user-defined constraints into one or more legally actionable portfolio configurations.

17. The computer-implemented method of claim 16, wherein simulating portfolio performance comprises applying one or more fundamental risk factors and one or more historical economic scenarios to a current holding, including at least one of: a past market crash, an interest rate spike, or an inflationary period, to generate stress test outputs rendered in the graphical user interface.

18. The computer-implemented method of claim 16, wherein each dynamically ranked portfolio configuration is scored using a rule-based algorithm that weights at least three user-specified factors and produces a composite suitability score displayed next to each configuration.

19. The computer-implemented method of claim 16, wherein the graphical user interface is further configured to render interactive sliders or toggles that allow each investment entity to adjust a priority weighting and to regenerate one or more rankings.

20. The computer-implemented method of claim 16, wherein presenting the ranked portfolio configurations further comprises generating at least one of a downloadable legal framework template, including an investment percentage, a termination condition, or a fee apportionment between each of the investment entities.

21. A non-transitory computer-readable medium comprising program code executable by one or more processors to perform operations including:
displaying, on a user interface, portfolio options for joint utilization by two or more investment companies (ICs), the portfolio options configured to increase a likelihood of achieving complementary investment objectives of the ICs;
receiving, via a data aggregation module, data in multiple formats from multiple computing systems, the data comprising information associated with the complementary objectives of the ICs;
obtaining securities holdings from existing portfolios and analyzing the securities based on characteristics associated with the complementary objectives of the ICs, the characteristics including, but not limited to, compound annual growth rate (CAGR), volatility, beta, alpha, correlation to benchmark indices, correlation between portfolios, Sharpe ratio, standard deviation, R² value, and tenure of portfolio managers;
configuring, on the user interface, a dynamic tool to display one or more single portfolios and combinations of portfolios, wherein the dynamic tool outputs analysis results including one or more identified characteristics and financial metrics such as current yield, yield CAGR, and portfolio manager tenure;
generating and displaying graphical representations of:
single portfolios optimized for actual money flows and increases in principal, and
combinations of portfolios optimized for actual money flows and increases in principal, including visualizations of the identified portfolio characteristics;
providing outcome data representing historical and projected performance of single portfolios and combinations of portfolios;
dynamically ranking the single portfolios and combinations of portfolios using alternative weightings of one or more selected portfolio characteristics;
receiving user input specifying percentage investments by each IC and, optionally, termination dates for one or more ICs;
displaying graphical representations of investment percentages for each IC relative to a total portfolio, including alternative optimization scenarios based on varying prioritizations of investment factors;
continually performing the operations above and providing updated results through a graphical user interface;
enabling each IC to select and invest in one or more portfolios relative to the total investments that meet parameters of the complementary objectives of each IC; and
facilitating allocation of invested amounts into selected portfolios in accordance with the complementary objectives of the ICs.

22. The non-transitory computer-readable medium of claim 21, wherein the one or more processors are further configured to dynamically display, on the user interface, graphical representations of multiple portfolio orderings based on various prioritizations of the selected portfolio characteristics.

23. The non-transitory computer-readable medium of claim 21, wherein the one or more processors are further configured to display, on the user interface, graphical representations of the one or more combinations of portfolios.

24. The non-transitory computer-readable medium of claim 21, wherein the one or more processors are further configured to receive, through the user interface, user input specifying a percentage investment in each of the one or more single portfolios by each of the two or more ICs.

25. The non-transitory computer-readable medium of claim 21, wherein the one or more processors are further configured to receive, through the user interface, user input specifying a termination date for one or more of the two or more ICs.

26. The non-transitory computer-readable medium of claim 21, wherein the one or more processors are further configured to:
display, on the user interface, graphical representations of investment percentages for each of the two or more ICs relative to the total portfolio, including alternative optimizations based on varying prioritizations of investment factors;
continually perform the operations recited in claim 21 and provide updated graphical user interface output;
enable each of the two or more ICs to invest in the one or more single portfolios relative to total investments that meet one or more parameters of the complementary investment objectives of each IC; and
allocate, by the one or more processors, invested amounts into the selected one or more portfolios in accordance with the complementary investment objectives of each IC.

27. The non-transitory computer-readable medium of claim 21, wherein the one or more processors are further configured to display, on the user interface, a graphical dashboard configured to display multiple investment portfolios and the one or more combinations of portfolios.

28. The non-transitory computer-readable medium of claim 21, wherein the data displayed on the user interface by the one or more processors includes portfolio-related information comprising portfolio characteristics, financial metrics, and performance data.

29. The non-transitory computer-readable medium of claim 21, wherein the one or more processors are further configured to display, on the user interface, a graphical dashboard configured to compare multiple portfolios and the one or more combinations of portfolios.

30. The non-transitory computer-readable medium of claim 21, wherein the one or more processors are further configured to manage principal-oriented ICs such that the principal-oriented ICs pay no fees and receive no money flows until reaching a specified termination date.

31. The non-transitory computer-readable medium of claim 21, wherein the one or more processors are further configured to calculate fees and expenses associated with the one or more portfolios, and deduct the calculated fees and expenses from incoming funds to the respective portfolios.

32. The non-transitory computer-readable medium of claim 21, wherein the one or more processors are further configured to allocate net money flows, after payment of one or more fees or expenses, to money-flow-oriented ICs until the specified termination date.

33. The non-transitory computer-readable medium of claim 21, wherein the one or more processors are further configured to, upon reaching the termination date, deactivate one or more money-flow-oriented ICs and initiate distribution of funds to IC investors based on original offering market values for each IC.

34. The non-transitory computer-readable medium of claim 21, wherein the one or more processors are further configured to, after the termination date, allocate all remaining assets to one or more principal-oriented ICs and debit all remaining fees and expenses from the one or more portfolios.

35. The non-transitory computer-readable medium of claim 21, wherein the one or more processors are further configured to, after the termination date of a money-flow-oriented IC, allocate at least one asset to one or more principal-oriented ICs, and calculate and debit fees and expenses from one or more respective asset values proportionally.
